(19) United States
(12) Patent Application Publication
(10) Pub. No.: US 2024/0421961 A1
(43) Pub. Date: Dec. 19, 2024

(54) INDICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Zhihua SHI, Dongguan (CN)

(21) Appl. No.: 18/819,822

(22) Filed: Aug. 29, 2024

Related U.S. Application Data
(63) Continuation of application No. PCT/CN2022/088017, filed on Apr. 20, 2022.

(51) Int. Cl. H04L 5/00

(52) U.S. Cl. CPC H04L 5/0053; H04L 5/0091

(57) ABSTRACT

An indication method includes: receiving, by a terminal device, indication information, and the indication information is used for indicating a combination of a number of transmission layers of at least one uplink channel.

### CROSS-REFERENCE TO RELATED APPLICATION

This application is a Continuation Application of International Application No. PCT/CN2022/088017 filed on Apr. 20, 2022, which is incorporated herein by reference in its entirety.

### TECHNICAL FIELD

The present disclosure relates to the field of communications, and more particularly, to an indication method, a terminal device, and a network device.

### BACKGROUND

In a fifth generation mobile communication technology (5G) new radio (NR) system, a network device may schedule a terminal device to transmit multiple uplink channels, and indicate a number of transmission layers used by the terminal device when transmitting the uplink channels. However, numbers of transmission layers indicated by the network device for different uplink channels are same, and it is impossible to indicate different numbers of transmission layers for different uplink channels, which results in limitations on uplink channel transmissions of the terminal device.

### SUMMARY

Embodiments of the present disclosure provide an indication method, a terminal device, and a network device.

The embodiments of the present disclosure provide an indication method, which including:
receiving, by a terminal device, indication information, the indication information being used for indicating a combination of a number of transmission layers of at least one uplink channel.

The embodiments of the present disclosure provide an indication method, which including:
transmitting, by a network device, indication information, the indication information being used for indicating a combination of a number of transmission layers of at least one uplink channel.

The embodiments of the present disclosure provide an indication device, which including:
a first receiving module, configured to receive indication information, the indication information being used for indicating a combination of a number of transmission layers of at least one uplink channel.

The embodiments of the present disclosure provide an indication device, which including:
a second transmitting module, configured to transmit indication information, the indication information being used for indicating a combination of a number of transmission layers of at least one uplink channel.

The embodiments of the present disclosure provide a terminal device, which including a processor and a memory. The memory is configured to store a computer program, and the processer is configured to invoke and execute the computer program stored in the memory, to cause the terminal device to perform the above indication method.

The embodiments of the present disclosure provide a network device, which including a processor and a memory. The memory is configured to store a computer program, and the processer is configured to invoke and execute the computer program stored in the memory, to cause the network device to perform the above indication method.

The embodiments of the present disclosure provide a chip to implement the above indication methods.

Exemplarily, the chip includes a processor, and the processer is configured to invoke and execute a computer program from a memory, to cause a device equipped with the chip to perform the above indication methods.

The embodiments of the present disclosure provide a computer readable storage medium to store a computer program, and the computer program, when being executed by a device, causes the device to perform the above indication methods.

The embodiments of the present disclosure provide a computer program product, which including computer program instructions. The computer program instructions cause a computer to perform the above indication methods.

The embodiments of the present disclosure provide a computer program, where the computer program, when being executed on a computer, causes the computer to perform the above indication methods.

### BRIEF DESCRIPTION OF THE DRAWINGS

FIG. 1 is a schematic diagram of an application scenario according to embodiments of the present disclosure.

FIG. 2 is a schematic flowchart of an indication method 200 according to an embodiment of the present disclosure.

FIG. 3 is a schematic flowchart of an indication method 300 according to another embodiment of the present disclosure.

FIG. 4A is a schematic diagram of a first example of interactions between a terminal device and a network device.

FIG. 4B is a schematic diagram of a second example of interactions between a terminal device and a network device.

FIG. 4C is a schematic diagram of a third example of interactions between a terminal device and a network device.

FIG. 4D is a schematic diagram of a fourth example of interactions between a terminal device and a network device.

FIG. 5 is a schematic flowchart of an indication method 500 according to an embodiment of the present disclosure.

FIG. 6 is a schematic block diagram of a terminal device 600 according to an embodiment of the present disclosure.

FIG. 7 is a schematic block diagram of a terminal device 700 according to another embodiment of the present disclosure.

FIG. 8 is a schematic block diagram of a network device 800 according to an embodiment of the present disclosure.

FIG. 9 is a schematic block diagram of a network device 900 according to another embodiment of the present disclosure.

FIG. 10 is a schematic block diagram of a communication device according to embodiments of the present disclosure.

FIG. 11 is a schematic block diagram of a chip according to embodiments of the present disclosure.

FIG. 12 is a schematic block diagram of a communication system according to embodiments of the present disclosure.

### DETAILED DESCRIPTION

Technical solutions in the embodiments of the present disclosure will be described below in conjunction with the accompanying drawings in the embodiments of the present disclosure.

The technical solutions of the embodiments of the present disclosure may be applied to various communication systems, such as, a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial communication network (Non-Terrestrial Networks, NTN) system, a universal mobile telecommunication system (UMTS), wireless local area networks (WLAN), wireless fidelity (WiFi), a fifth-generation communication (5th-Generation, 5G) system, or other communication systems.

Generally speaking, traditional communication systems support a limited number of connections which are easy to be implemented. However, with development of the communication technology, mobile communication systems will support not only the traditional communication, but also, for example, device to device (D2D) communication, machine to machine (M2M) communication, machine type communication (MTC), vehicle to vehicle (V2V) communication, or vehicle to everything (V2X) communication. The embodiments of the present disclosure may also be applied to these communication systems.

In a possible implementation, a communication system in the embodiments of the present disclosure may be applied to a carrier aggregation (CA) scenario, may also be applied to a dual connectivity (DC) scenario, and may also be applied to a standalone (SA) network deployment scenario.

In a possible implementation, the communication system in the embodiments of the present disclosure may be applied to an unlicensed spectrum, where the unlicensed spectrum may also be considered as a shared spectrum; or the communication system in the embodiments of the present disclosure may also be applied to a licensed spectrum, where the licensed spectrum may also be considered as an unshared spectrum.

In the embodiments of the present disclosure, each embodiment will be described in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user apparatus, or the like.

The terminal device may be a station (STATION, ST) in the WLAN, which may be a cellular phone, a cordless phone, a session initiation protocol (SIP) phone, a wireless local loop (WLL) station, or a personal digital assistant (PDA) device, a handheld device with wireless communication functions, a computing device or other processing devices connected to a wireless modem, an in-vehicle device, a wearable device, a terminal device in a next generation communication system (e.g., an NR network), a terminal device in a future evolved public land mobile network (PLMN) network, or the like.

In the embodiments of the present disclosure, the terminal device may be deployed on land, which includes indoor or outdoor, handheld, wearable, or in-vehicle; the terminal device may also be deployed on water (e.g., on a steamship); and the terminal device may also be deployed in air (e.g., on an airplane, on a balloon, or on a satellite).

In the embodiments of the present disclosure, the terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, or the like.

As an example but not a limitation, in the embodiments of the present disclosure, the terminal device may also be a wearable device. The wearable device may also be referred to as a wearable smart device, which is a generic term for a wearable device by using wearable technology and intelligent design for everyday wear, such as glasses, gloves, a watch, clothing, or shoes. The wearable device is a portable device that is worn directly on a body, or integrated into a user's clothing or accessories. The wearable device is not only a hardware device, but also achieves powerful functions through software supporting as well as data interaction or cloud interaction. Generalized wearable smart devices includes full-featured, large-sized devices that may implement full or partial functionality without relying on smart phones, such as a smart watch or smart glasses, and devices that focus on a certain type of application functionality only and need to be used in conjunction with other devices (such as smart phones), such as various smart bracelets or smart jewelries for monitoring physical signs.

In the embodiments of the disclosure, the network device may be a device used for communicating with a mobile device. The network device may be an access point (AP) in the WLAN, a base station (Base Transceiver Station, BTS) in the GSM or CDMA, may also be a base station (NodeB, NB) in the WCDMA, or may also be an evolutional base station (Evolutional Node B, eNB or eNodeB) in the LTE, a relay station or an access point, a network device (gNB) in an in-vehicle device, a wearable device and an NR network, a network device in the future evolved PLMN network, a network device in the NTN network, or the like.

As an example but not a limitation, in the embodiments of the present disclosure, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite. Optionally, the network device may also be a base station deployed on land, water, and other places.

In the embodiments of the present disclosure, the network device may provide services for a cell, and the terminal device communicates with the network device through transmission resources (such as a frequency domain resources, or frequency spectrum resources) used by the cell. The cell may be a cell corresponding to the network device (such as the base station). The cell may belong to a macro base station or a base station corresponding to a small cell. The small cell here may include a metro cell, a micro cell, a pico cell, a femto cell, or the like. These small cells have characteristics of small coverage range and low transmission power, which are applicable for providing a data transmission service with high speed.

FIG. 1 exemplarily illustrates a communication system 100. The communication system includes one network device 110 and two terminal devices 120. In a possible implementation, the communication system 100 may include multiple network devices 110, and may include other numbers of terminal devices 120 within a coverage range of each network device 110, which is not limited in the embodiments of the present disclosure.

In a possible implementation, the communication system 100 may also include other network entities such as a mobility management entity (MME), an access and mobility management function (AMF), which are not limited in the embodiments of the present disclosure.

The network device may also include an access network device and a core network device. That is, the wireless communication system also includes multiple core networks for communicating with the access network device. The access network device may be a evolutional base station (evolutional node B, abbreviated as eNB or e-NodeB), a macro base station, a micro base station (also referred to as a “small base station”), a pico base station, an access point (AP), a transmission point (TP), a new generation base station (new generation Node B, gNodeB) or the like, in a long-term evolution (LTE) system, a next generation (mobile communication system) (next radio, NR) system or an authorized auxiliary access long-term evolution (LAA-LTE) system.

It should be understood that a device having a communication function in the network or system in the embodiments of the present disclosure may be referred to as a communication device. Taking the communication system shown in FIG. 1 as an example, the communication device may include the network device and the terminal device with the communication function, and the network device and the terminal device may be the specific devices in the embodiments of the present disclosure, which will not be repeated here; the communication device may also include other devices in the communication system, such as a network controller, a mobility management entity, and other network entities, which are not limited in the embodiments of the present disclosure.

It should be understood that, the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that, “indication” mentioned in the embodiments of the present disclosure may be direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present disclosure, the term “correspondence” may mean that there is a direct correspondence or indirect correspondence between the two, it may also mean that there is an associated relationship between the two, or it may also mean a relationship of indicating and being indicated, a relationship of configuring and being configured, or the like.

In order to facilitate understanding of the technical solutions of the embodiments of the present disclosure, related technologies of the embodiments of the present disclosure are described below, and the following related technologies may be, as optional solutions, arbitrarily combined with the technical solutions of the embodiments of the present disclosure, all of which belong to the protection scope of the embodiments of the present disclosure.

Transmission schemes of a physical uplink shared channel (PUSCH) include a transmission scheme based on codebook and a transmission scheme based on noncodebook.

The transmission scheme based on codebook mainly includes the following processes:
1) user equipment (UE) transmits a sounding reference signal (SRS) used for codebook to a network device;
2) the network device performs uplink channel detection according to the SRS transmitted by the UE, performs resource scheduling for the UE, and determines SRS resources, a number of layers for a uplink transmission, a precoding matrix, or the like, corresponding to a transmission of a PUSCH; and the network device indicates above information to the terminal device through downlink control information (DCI); and
3) the terminal device receives the DCI and transmits the PUSCH according to an indication of the DCI.

Processes of the transmission scheme based on noncodebook include:
1) UE measures a downlink reference signal, to obtain a candidate precoding matrix, and after precoding a sounding reference signal (SRS) by using the candidate precoding matrix, transmits the SRS used for a noncodebook to a network device;
2) the network device performs uplink channel detection according to the SRS transmitted by the UE, performs resource scheduling for the UE, and determines SRS resources corresponding to a beam transmitted by a PUSCH; and the network device indicates above information to the terminal device through downlink control information (DCI); and
3) the terminal device receives the DCI and transmits the PUSCH according to indications of the DCI.

In the transmission scheme based on noncodebook, the network device indicates a number of transmission layers of the PUSCH and SRS resources in an SRS resource set to the terminal device through an SRS resource indicator (SRI) field in the DCI.

Non-coherent transmissions of downlink and uplink based on multiple transmission reception points (TRPs) are introduced in a New Radio (NR) system. A UE may transmit PUSCHs to two TRPs in a time division multiplexing (TDM) manner. A network device may schedule a terminal device through one DCI to transmit PUSCHs to two TRPs. The PUSCHs transmitted to the two TRPs may be configured with independent transmission parameters, such as beams and precoding matrixes, but are constrained to have a same number of transmission layers of the PUSCHs transmitted to two TRPs. In a case where the terminal is configured with multiple antenna panels and supports simultaneous transmission of PUSCH on the multiple panels, if different signals are simultaneously transmitted on different panels using different beams, transmission distances between the terminal and different receiving TRPs are different, and channel conditions of different panels may be different, numbers of transmission layers of PUSCHs transmitted through the multiple panels may be different. However, it is impossible to indicate different numbers of transmission layers in the related art, which results in limitations on uplink transmissions of the terminal device.

The embodiments of the present disclosure provide an indication method, and the method includes:
receiving, by a terminal device, indication information, the indication information being used for indicating a combination of a number of transmission layers of at least one uplink channel.

In some embodiments, each uplink channel is associated with a spatial parameter, and the spatial parameter includes at least one of: transmission configuration indicator (TCI) state information, capability set information, antenna panel information, transmission reception point (TRP) information, control resource set (CORESET) information, reference signal set information, an SRS resource set, reference signal information, or beam information.

In some embodiments, the indication information includes first information, and the first information is used for indicating the combination of the number of transmission layers of the at least one uplink channel.

In some embodiments, the indication information further includes second information, and the second information is used for indicating an association relationship between the combination of the number of transmission layers of the at least one uplink channel and a spatial parameter.

In some embodiments, where, in a case where a quantity of a number of transmission layers included in the combination of the number of transmission layers of the at least one uplink channel is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter.

In some embodiments, where, in a case where a quantity of a number of transmission layers included in the combination of the number of transmission layers of the at least one uplink channel is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

In some embodiments, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some embodiments, second information is further used for indicating an association relationship of the combination of the number of transmission layers of the at least one uplink channel with the first SRS resource indicator and/or the second SRS resource indicator.

In some embodiments, where, in a case where a quantity of a number of transmission layers included in the combination of the number of transmission layers of the at least one uplink channel is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator.

In some embodiments, where, in a case where a quantity of a number of transmission layers included in the combination of the number of transmission layers of the at least one uplink channel is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

In some embodiments, the indication information further includes first precoding information and/or second precoding information.

In some embodiments, the second information is further used for indicating an association relationship of the combination of the number of transmission layers of the at least one uplink channel with the first precoding information and/or the second precoding information.

In some embodiments, where, in a case where a quantity of a number of transmission layers included in the combination of the number of transmission layers of the at least one uplink channel is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information.

In some embodiments, where, in a case where a quantity of a number of transmission layers included in the combination of the number of transmission layers of the at least one uplink channel is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

In some embodiments, the indication information includes third information, and the third information is used for indicating the combination of the number of transmission layers of the at least one uplink channel and an association relationship between the combination of the number of transmission layers of the at least one uplink channel and a spatial parameter.

In some embodiments, m1 first bits in the third information indicate a number of transmission layers associated with a first spatial parameter in the combination of the number of transmission layers of the at least one uplink channel; and
m2 second bits in the third information indicate a number of transmission layers associated with a second spatial parameter in the combination of the number of transmission layers of the at least one uplink channel; where
m1 and m2 are positive integers.

In some embodiments, the first bits are most significant bits (MSBs) and the second bits are least significant bits (LSBs); or
the first bits are LSBs and the second bits are MSBs.

In some embodiments, k1 state values of the third information indicate a number of transmission layers associated with a first spatial parameter;
k2 state values of the third information indicate a number of transmission layers associated with a second spatial parameter; and
k3 state values of the third information indicate a number of transmission layers associated with a first spatial parameter and a number of transmission layers associated with a second spatial parameter, respectively; where
k1, k2 and k3 are positive integers.

In some embodiments, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some embodiments, the third information is further used for indicating an association relationship of the combination of the number of transmission layers of the at least one uplink channel with the first SRS resource indicator and/or the second SRS resource indicator.

In some embodiments, a number of SRS ports of an SRS resource configuration indicated by the first SRS resource indicator and/or the second SRS resource indicator is greater than or equal to a number of associated transmission layers.

In some embodiments, the indication information further includes first precoding information and/or second precoding information.

In some embodiments, the third information is further used for indicating an association relationship of the combination of the number of transmission layers of the at least one uplink channel with the first precoding information and/or the second precoding information.

In some embodiments, the method further includes:
transmitting, by the terminal device, the at least one uplink channel according to the indication information.

In some embodiments, where transmitting, by the terminal device, the at least one uplink channel according to the indication information includes:
determining, by the terminal device according to the indication information, at least one of:
the number of transmission layers of the at least one uplink channel;
a spatial parameter associated with a number of transmission layers of each uplink channel;
an SRS resource indicator associated with a number of transmission layers of each uplink channel; or
precoding information associated with a number of transmission layers of each uplink channel; and
transmitting, by the terminal device, an uplink channel according to determined content.

In some embodiments, where transmitting, by the terminal device, the at least one uplink channel according to the indication information includes: determining, by the terminal device according to the indication information, at least one of:
the number of transmission layers of the at least one uplink channel;
a spatial parameter associated with a number of transmission layers of each uplink channel; or
an SRS resource indicator associated with a number of transmission layers of each uplink channel; and
transmitting, by the terminal device, an uplink channel according to determined content.

In some embodiments, a quantity of a number of transmission layers in the combination of the number of transmission layers of the at least one uplink channel is associated with a capability of the terminal device.

In some embodiments, the quantity of the number of transmission layers in the combination of the number of transmission layers of the at least one uplink channel being associated with the capability of the terminal device includes:
in a case where the terminal device supports simultaneous transmission of multi-antenna panels, the quantity of the number of transmission layers included in the combination of the number of transmission layers of the at least one uplink channel being multiple; or
in a case where the terminal device does not support simultaneous transmission of multi-antenna panels, the quantity of the number of transmission layers included in the combination of the number of transmission layers of the at least one uplink channel being one.

In some embodiments, a sum of layers of a number of transmission layers in the combination of the number of transmission layers of the at least one uplink channel is less than or equal to a maximum number of transmission layers supported by the terminal device.

In some embodiments, the maximum number of transmission layers includes:
a maximum number of transmission layers supported by the terminal device on an uplink channel associated with multiple spatial parameters; or
a sum of a maximum number of transmission layers supported by the terminal device on an uplink channel associated with each spatial parameter; or
a maximum number of transmission layers supported by the terminal device.

In some embodiments, each number of transmission layers in the combination of the number of transmission layers of the at least one uplink channel is less than or equal to a maximum number of transmission layers supported by the terminal device on an uplink channel associated with a corresponding spatial parameter.

The embodiments of the present disclosure provide an indication method, and the method includes:
transmitting, by a network device, indication information, the indication information being used for indicating a combination of a number of transmission layers of at least one uplink channel.

In some embodiments, each uplink channel is associated with a spatial parameter, and the spatial parameter includes at least one of: transmission configuration indicator (TCI) state information, capability set information, antenna panel information, transmission reception point (TRP) information, control resource set (CORESET) information, reference signal set information, an SRS resource set, reference signal information, or beam information.

In some embodiments, the indication information includes first information, and the first information is used for indicating the combination of the number of transmission layers of the at least one uplink channel.

In some embodiments, the indication information further includes second information, and the second information is used for indicating an association relationship between the combination of the number of transmission layers of the at least one uplink channel and a spatial parameter.

In some embodiments, where, in a case where a quantity of a number of transmission layers included in the combination of the number of transmission layers of the at least one uplink channel is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter.

In some embodiments, where, in a case where a quantity of a number of transmission layers included in the combination of the number of transmission layers of the at least one uplink channel is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

In some embodiments, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some embodiments, second information is further used for indicating an association relationship of the combination of the number of transmission layers of the at least one uplink channel with the first SRS resource indicator and/or the second SRS resource indicator.

In some embodiments, where, in a case where a quantity of a number of transmission layers included in the combination of the number of transmission layers of the at least one uplink channel is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator.

In some embodiments, where, in a case where a quantity of a number of transmission layers included in the combination of the number of transmission layers of the at least one uplink channel is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

In some embodiments, the indication information further includes first precoding information and/or second precoding information.

In some embodiments, the second information is further used for indicating an association relationship of the combination of the number of transmission layers of the at least one uplink channel with the first precoding information and/or the second precoding information.

In some embodiments, where, in a case where a quantity of a number of transmission layers included in the combination of the number of transmission layers of the at least one uplink channel is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information.

In some embodiments, where, in a case where a quantity of a number of transmission layers included in the combination of the number of transmission layers of the at least one uplink channel is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

In some embodiments, the indication information includes third information, and the third information is used for indicating the combination of the number of transmission layers of the at least one uplink channel and an association relationship between the combination of the number of transmission layers of the at least one uplink channel and a spatial parameter.

In some embodiments, m1 first bits in the third information indicate a number of transmission layers associated with a first spatial parameter in the combination of the number of transmission layers of the at least one uplink channel; and
m2 second bits in the third information indicate a number of transmission layers associated with a second spatial parameter in the combination of the number of transmission layers of the at least one uplink channel; where
m1 and m2 are positive integers.

In some embodiments, the first bits are most significant bits (MSBs) and the second bits are least significant bits (LSBs); or
the first bits are LSBs and the second bits are MSBs.

In some embodiments, k1 state values of the third information indicate a number of transmission layers associated with a first spatial parameter;
k2 state values of the third information indicate a number of transmission layers associated with a second spatial parameter; and
k3 state values of the third information indicate a number of transmission layers associated with a first spatial parameter and a number of transmission layers associated with a second spatial parameter, respectively; where
k1, k2 and k3 are positive integers.

In some embodiments, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some embodiments, the third information is further used for indicating an association relationship of the combination of the number of transmission layers of the at least one uplink channel with the first SRS resource indicator and/or the second SRS resource indicator.

In some embodiments, a number of SRS ports of an SRS resource configuration indicated by the first SRS resource indicator and/or the second SRS resource indicator is greater than or equal to a number of associated transmission layers.

In some embodiments, the indication information further includes first precoding information and/or second precoding information.

In some embodiments, the third information is further used for indicating an association relationship of the combination of the number of transmission layers of the at least one uplink channel with the first precoding information and/or the second precoding information.

In some embodiments, the method further includes:
receiving the at least one uplink channel transmitted according to the indication information.

In some embodiments, a quantity of a number of transmission layers in the combination of the number of transmission layers of the at least one uplink channel is associated with a capability of a terminal device.

In some embodiments, the quantity of the number of transmission layers in the combination of the number of transmission layers of the at least one uplink channel being associated with the capability of the terminal device includes:
in a case where the terminal device supports simultaneous transmission of multi-antenna panels, the quantity of the number of transmission layers included in the combination of the number of transmission layers of the at least one uplink channel being multiple; or
in a case where the terminal device does not support simultaneous transmission of multi-antenna panels, the quantity of the number of transmission layers included in the combination of the number of transmission layers of the at least one uplink channel being one.

In some embodiments, a sum of layers of a number of transmission layers in the combination of the number of transmission layers of the at least one uplink channel is less than or equal to a maximum number of transmission layers supported by a terminal device.

In some embodiments, the maximum number of transmission layers includes:
a maximum number of transmission layers supported by the terminal device on an uplink channel associated with multiple spatial parameters; or
a sum of a maximum number of transmission layers supported by the terminal device on an uplink channel associated with each spatial parameter; or
a maximum number of transmission layers supported by the terminal device.

In some embodiments, each number of transmission layers in the combination of the number of transmission layers of the at least one uplink channel is less than or equal to a maximum number of transmission layers supported by the terminal device on an uplink channel associated with a corresponding spatial parameter.

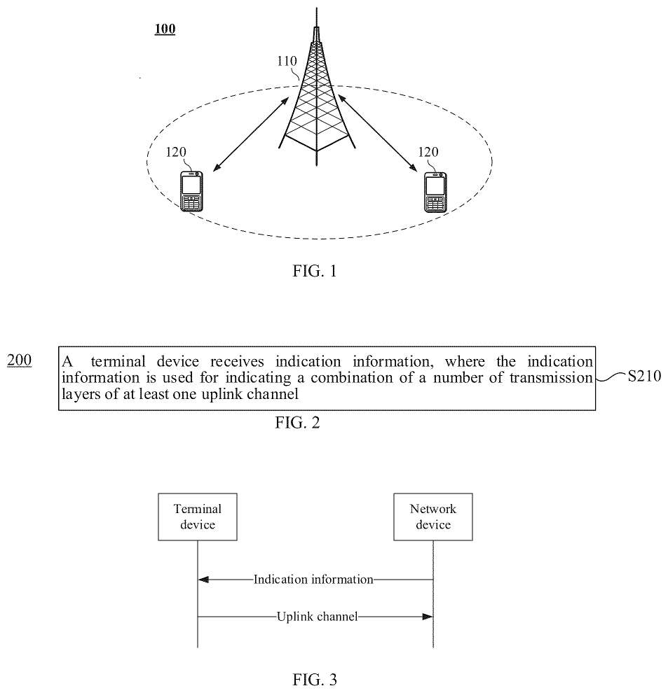

FIG. 2 is a schematic flowchart of an indication method 200 according to an embodiment of the present disclosure. Optionally, the method may be applied to the system shown in FIG. 1, but is not limited thereto. The method includes at least part of the following content.

S210, a terminal device receives indication information, where the indication information is used for indicating a combination of a number of transmission layers of at least one uplink channel.

In this manner, different uplink channels of the terminal device may be indicated with different numbers of transmission layers.

In some implementations, the at least one uplink channel of the terminal device may be associated with different spatial parameters. A spatial parameter may refer to a spatial setting and/or spatial relation for an uplink channel transmission.

For example, each uplink channel is associated with a spatial parameter, and the spatial parameter includes at least one of: transmission configuration indicator (TCI) state information, capability set information, antenna panel information, TRP information, control resource set (CORESET) information, reference signal set information, a sounding reference signal (SRS) resource set, reference signal information, or beam information.

The capability set information may include one or more parameters. For example, the capability set information may be a capability set supported by the terminal device or reference signal information associated with the capability set supported by the terminal device. In some embodiments, the capability set information may include at least one of: a maximum number of SRS ports, a maximum number of transmission layers of uplink, a codebook subset type, a uplink full-power transmission mode, a SRS antenna switching capability, a SRS carrier switching capability, a number of SRS resources simultaneously transmitted, a maximum modulation scheme of an uplink data transmission, a maximum modulation scheme of an downlink data transmission, a number of hybrid automatic repeat request (HARQ) processes supported by the terminal device, a channel bandwidth supported by the terminal device, a number of transmission antennas supported by the terminal device, a processing capability of a physical downlink shared channel (PDSCH), a processing capability of a physical uplink shared channel (PUSCH), a power saving capability of the terminal device, a coverage enhancement capability of the terminal device, a data transmission rate enhancement capability of the terminal device, a short latency processing capability of the terminal device, a small data transmission capability of the terminal device, an inactive data transmission capability of the terminal device, a transmission reliability capability of the terminal device, an URLLC data transmission capability of the terminal device.

In addition, the terminal device may transmit the at least one uplink channel according to the indication information. FIG. 3 is a schematic flowchart of an indication method 300 according to an embodiment of the present disclosure. As shown in FIG. 3, after the terminal device receives the indication information from the network device, the terminal device may transmit the at least one uplink channel according to the indication information.

In some implementations, a quantity of a number of transmission layers included in the combination of the number of transmission layers of the at least one uplink channel indicated by the indication information may be one, two or more, and each number of transmission layers corresponds to one uplink channel.

In order to facilitate to describe, each number of transmission layers in the combination of the number of transmission layers of the at least one uplink channel may be referred to as an element in the combination, and accordingly, a quantity of a number of transmission layers in the combination of the number of transmission layers of the at least one uplink channel may be referred to as a quantity of elements in the combination. For example, a quantity of the number of transmission layers included in a combination of the number of transmission layers of an uplink channel is 2, where one of the number of transmission layers is 2 layers, and the other is 1 layer, and a quantity of elements in the combination of the number of transmission layers of the uplink channel is 2. For another example, a quantity of the number of transmission layers included in the combination of the number of transmission layers of an uplink channel is 1, the number of transmission layers is 2 layers, and a quantity of elements in the combination of the number of transmission layers of the uplink channel is 1.

The quantity of the number of transmission layers (i.e., the quantity of the elements) in the combination of the number of transmission layers of the at least one uplink channel may be associated with a capability of the terminal device.

For example, the quantity of the number of transmission layers in the combination of the number of transmission layers of the at least one uplink channel may be related to a quantity of capability sets of uplink multi-antenna panels reported by the terminal device to the network device.

Exemplarily, in a case where the terminal device supports simultaneous transmission of multi-antenna panels, the quantity of the number of transmission layers included in the combination of the number of transmission layers of the at least one uplink channel is multiple (e.g., the quantity of the elements is greater than or equal to 2); or
in a case where the terminal device does not support simultaneous transmission of multi-antenna panels, the quantity of the number of transmission layers included in the combination of the number of transmission layers of the at least one uplink channel is one (e.g., the quantity of the elements is 1).

For another example, the quantity of the number of transmission layers in the combination of the number of transmission layers of the at least one uplink channel may be related to a quantity of capability sets supported by the terminal device.

Exemplarily, in a case where the terminal device supports multiple capability sets, the quantity of the number of transmission layers included in the combination of the number of transmission layers of the at least one uplink channel is multiple (e.g., the quantity of the elements is greater than or equal to 2); or
in a case where the terminal device does not support multiple capability sets, the quantity of the number of transmission layers included in the combination of the number of transmission layers of the at least one uplink channel is one (e.g., the quantity of the elements is 1).

The above two examples are for illustrative purposes only, since the capabilities of the terminal device may be embodied in different manners, the quantity of the number of transmission layers in the combination of the number of transmission layers of the at least one uplink channel is determined in different manners, which will not be exhaustive herein.

In some implementations, a sum of layers of a number of transmission layers in the combination of the number of transmission layers of the at least one uplink channel is less than or equal to a maximum number of transmission layers supported by the terminal device.

The maximum number of transmission layers supported by the terminal device may have at least the following three meanings:
(1) a maximum number of transmission layers supported by the terminal device on an uplink channel associated with multiple spatial parameters;
(2) a sum of a maximum number of transmission layers supported by the terminal device on an uplink channel associated with each spatial parameter; or
(3) a maximum number of transmission layers supported by the terminal device.

Where the meanings of the above (1) and (3) are similar, the maximum number of transmission layers supported by the terminal device is unrelated to spatial parameters, but is related to the capabilities of the terminal device or configurations of the base station. In the above (2), the maximum number of transmission layers supported by the terminal device is related to the spatial parameters, the terminal device configures the maximum number of transmission layers supported on an uplink channel associated with each spatial parameter, and a maximum number of transmission layers transmitted by the terminal device needs to be less than the sum of the maximum number of transmission layers supported on the uplink channel associated with each spatial parameter.

For example, if the terminal device reports to the network device that the maximum number of transmission layers supported by the terminal device is 4, a sum of layers of all numbers of transmission layers in the combination of the number of transmission layers of the at least one uplink channel indicated by the network device to the terminal device should be less than or equal to 4. For example, a quantity of a number of transmission layers included in the combination of the number of transmission layers of the at least one uplink channel indicated by the network device to the terminal device is one, the number of transmission layers should be less than or equal to 4. For another example, a quantity of a number of transmission layers included in the combination of the number of transmission layers of the at least one uplink channel indicated by the network device to the terminal device is two, the sum of two numbers of transmission layers should be less than or equal to 4 (e.g., one of the number of transmission layers is 1 layer, and the other is 3 layers).

Alternatively, if the terminal device respectively reports a maximum number of transmission layers supported by the terminal device for an uplink channel associated with each spatial parameter when reporting to the network device, in order to ensure that the sum of the numbers of transmission layers in the combination of the number of transmission layers of the at least one uplink channel indicated by the indication information is less than or equal to the maximum number of transmission layers supported by the terminal device, each number of transmission layers indicated by the indication information is less than or equal to the maximum number of transmission layers of the uplink channel reported by the terminal device.

For example, if the terminal device reports to the network device that a maximum number of transmission layers supported by the terminal device is 2 for an uplink channel 1, and a maximum number of transmission layers supported by the terminal device is 1 for an uplink channel 2, where the uplink channel 1 is associated with a spatial parameter 1, and the uplink channel 2 is associated with a spatial parameter 2; and then, in the combination of the number of transmission layers indicated by the indication information, a number of transmission layers associated with the spatial parameter 1 should be less than or equal to 2, and a number of transmission layers associated with the spatial parameter 2 should be less than or equal to 1.

In some implementations, the indication information may indicate the combination of the number of transmission layers of the at least one uplink channel, and an association relationship between the combination of the number of transmission layers and a spatial parameter (or an association relationship between each number of transmission layers in the combination of the number of transmission layers and a corresponding spatial parameter). The foregoing content may be separately indicated by using two pieces of information (or two fields), or jointly indicated by using one piece of information (or one field). The indication information may also include other relevant information. According to the content indicated by the indication information, the terminal may perform transmissions based on codebook or transmissions based on noncodebook. The following introduces the above two indication manners, respectively.

### Manner One

A combination of a number of transmission layers of at least one uplink channel and an association relationship between the combination of the number of transmission layers of the at least one uplink channel and a spatial parameter are indicated, respectively.

For example, the indication information includes first information, and the first information is used for indicating the combination of the number of transmission layers of the at least one uplink channel (abbreviated as “the combination of the number of transmission layers”). The indication information may further include second information, and the second information is used for indicating an association relationship between the combination of the number of transmission layers of the at least one uplink channel and the spatial parameter.

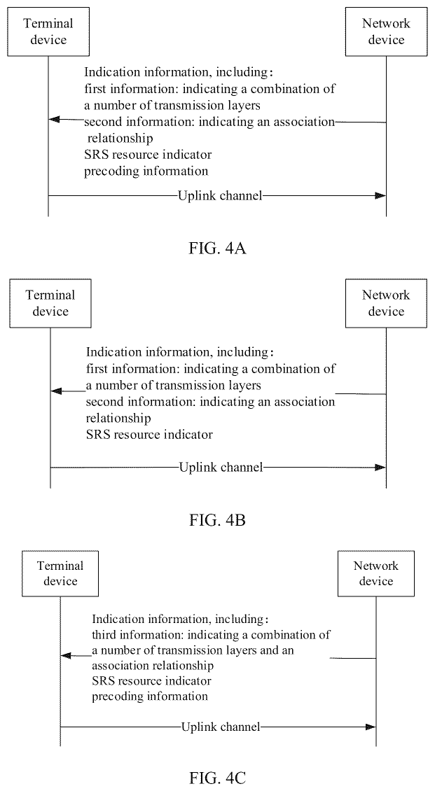

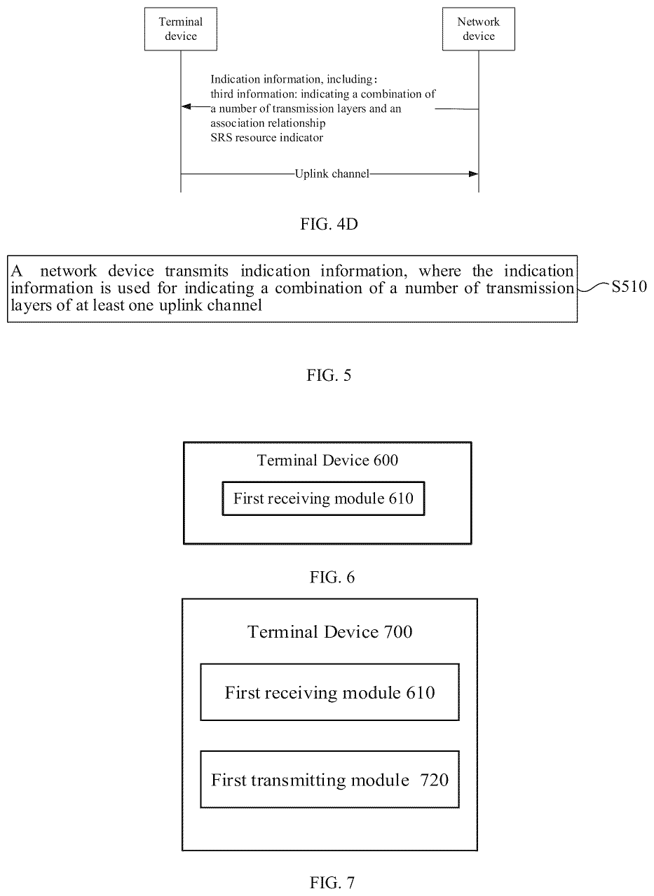

FIG. 4A is a schematic diagram of a first example of interactions between a terminal device and a network device. As shown in FIG. 4A, the network device transmits indication information to the terminal device, and the indication information includes the first information and the second information. The first information indicates the combination of the number of transmission layers, and the second information indicates the association between the combination of the number of transmission layers and the spatial parameter.

Taking the example that the at least one uplink channel is two uplink channels (that is, a quantity of the number of transmission layers included in the combination of the number of transmission layers is two), and a sum of layers of numbers of transmission layers included in the combination of the number of transmission layers does not exceed 4 layers, a length of the first information may be 3 bits. Table 1 is an indication manner of the first information:

TABLE 1

| State value of | The combination of the number |
|---|---|
| the first information | of transmission layers |
| 000 | A quantity of the number of |
| | transmission layers included in |
| | the combination of the number of |
| | transmission layers is 1, and the |
| | number of transmission layers is |
| | 1 layer. |
| 001 | A quantity of the number of |
| | transmission layers included in |
| | the combination of the number of |
| | transmission layers is 1, and the |
| | number of transmission layers is |
| | 2 layers. |
| 010 | A quantity of the number of |
| | transmission layers included in |
| | the combination of the number of |
| | transmission layers is 1, and the |
| | number of transmission layers is |
| | 3 layers. |
| 011 | A quantity of the number of |
| | transmission layers included in |
| | the combination of the number of |
| | transmission layers is 1, and the |
| | number of transmission layers is |
| | 4 layers. |
| 100 | A quantity of the number of |
| | transmission layers included in |
| | the combination of the number of |
| | transmission layers are 1 layer |
| | and 1 layer, respectively. |
| 101 | A quantity of the number of |
| | transmission layers included in |
| | the combination of the number of |
| | transmission layers is 2, and two |
| | numbers of transmission layers |
| | are 2 layers and 1 layer, |
| | respectively. |
| 110 | A quantity of the number of |
| | transmission layers included in |
| | the combination of the number of |
| | transmission layers is 2, and two |
| | numbers of transmission layers |
| | are 3 layers and 1 layer, |
| | respectively. |
| 111 | A quantity of the number of |
| | transmission layers included in |
| | the combination of the number of |
| | transmission layers is two, and |
| | two numbers of transmission |
| | layers are 2 layers and 2 |
| | layers, respectively. |

As can be seen from the Table 1, a first bit in the state value of the first information may indicate the quantity of the elements in the combination of the number of transmission layers. For example, when a value of the first bit is 0, it is indicated that the quantity of the elements in the combination of the number of transmission layers is 1; and when the value of the first bit is 1, it is indicated that the quantity of the elements in the combination of the number of transmission layers is 2.

Table 1 is merely an indication example of the first information, and the indication form of the first information is not limited by the embodiments of the present disclosure.

The second information may indicate the association relationship between the combination of the number of transmission layers and the spatial parameter, and a length of the second information may be 1 bit.

In some implementations, in a case where a quantity of a number of transmission layers included in the combination of the number of transmission layers indicated by the first information is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter.

For example, in a case where a state value of a part of bits in the first information indicate that the quantity of the number of transmission layers included in the combination of the number of transmission layers is one (as shown in Table 1 above, when the value of the first bit in the first information is 0, it is indicated that one number of transmission layers is included), when the value of the second information is 0, it is indicated that the number of transmission layers is associated with the first spatial parameter; and when the value of the second information is 1, it is indicated that the number of transmission layers is associated with the second spatial parameter. Alternatively, when the value of the second information is 1, it is indicated that the number of transmission layers is associated with the first spatial parameter; and when the value of the second information is 0, it is indicated that the number of transmission layers is associated with the second spatial parameter.

In some implementations, in a case where a quantity of a number of transmission layers included in the combination of the number of transmission layers indicated by the first information is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

For example, in a case where a state value of a part of bits in the first information indicate that the quantity of the number of transmission layers included in the combination of the number of transmission layers is multiple (as shown in Table 1 above, when the value of the first bit in the first information is 1, it is indicated that two numbers of transmission layers are included), the second information is used for indicating an association order of the numbers of transmission layers in the combination of the number of transmission layers and the spatial parameters. For example, when the value of the second information is 0, it is indicated that the first number of transmission layers and the second number of transmission layers in the combination of the number of transmission layers are associate with the first spatial parameter and the second spatial parameter, respectively, (that is, the numbers of transmission layers and the spatial parameters are associated in a same order); and when the value of the second information is 1, it is indicated that the first number of transmission layers and the second number of transmission layers in the combination of the number of transmission layers are associate with the second spatial parameter and the first spatial parameter, respectively, (that is, the numbers of transmission layers and the spatial parameters are associated in a reverse order), as shown in Table 2. Alternatively, when the value of the second information is 0, it is indicated that the first number of transmission layers and the second number of transmission layers in the combination of the number of transmission layers are associated with the second spatial parameter and the first spatial parameter, respectively; and when the value of the second information is 1, it is indicated that the first number of transmission layers and the second number of transmission layers in the combination of the number of transmission layers are associated with the first spatial parameter and the second spatial parameter, respectively.

Table 2 is an indication manner of the second information:

TABLE 2

| State value | The combination of | State value of the second |
|---|---|---|
| of the first | the number of | information and an association |
| information | transmission layers | relationship indicated thereof |
| 000 | A quantity of the number | The state value equals to 0, it is |
| | of transmission layers | indicated that the number of |
| | included in the | transmission layers is associated with |
| | combination of the | the first spatial parameter; and |
| | number of transmission | the state value equals to 1, it is |
| | layers is one, and the | indicated that the number of |
| | number of transmission | transmission layers is associated |
| | layers is 1 layer. | with the second spatial parameter. |
| 001 | A quantity of the | |
| | number of transmission | |
| | layers included in the | |
| | combination of the | |
| | number of transmission | |
| | layers is one, and the | |
| | number of transmission | |
| | layers is 2 layers. | |
| 010 | A quantity of the | |
| | number of transmission | |
| | layers included in the | |
| | combination of the | |
| | number of transmission | |
| | layers is one, and the | |
| | number of transmission | |
| | layers is 3 layers. | |
| 011 | A quantity of the | |
| | number of transmission | |
| | layers included in the | |
| | combination of the | |
| | number of transmission | |
| | layers is one, and the | |
| | number of transmission | |
| | layers is 4 layers. | |
| 100 | A quantity of the | The state value equals to 0, |
| | number of transmission | it is indicated that the two |
| | layers included in the | numbers of transmission layers |
| | combination of the | are associated with the first |
| | number of transmission | spatial parameter and the |
| | layers is two, and | second spatial parameter, |
| | two numbers of | respectively; and the |
| | transmission layers | state value equals to 1, |
| | are 1 layer and 1 | it is indicated that the |
| | layer, respectively. | two numbers of transmission |
| 101 | A quantity of the | layers are associated with the |
| | number of transmission | second spatial parameter and |
| | layers included in | the first spatial parameter, |
| | the combination of | respectively. |
| | the number of | |
| | transmission layers | |
| | are two, and two | |
| | numbers of | |
| | transmission layers | |
| | are 2 layers and 1 | |
| | layer, respectively. | |
| 110 | A quantity of the | |
| | number of transmission | |
| | layers included in the | |
| | combination of the | |
| | number of transmission | |
| | layers is two, and | |
| | two numbers of | |
| | transmission layers | |
| | are 3 layers and 1 | |
| | layer, respectively. | |
| 111 | A quantity of the | |
| | number of transmission | |
| | layers included in | |
| | the combination of | |
| | the number of | |
| | transmission layers is | |
| | two, and two numbers | |
| | of transmission layers | |
| | are 2 layers and 2 | |
| | layers, respectively. | |

Table 2 is merely an indication example of the second information, and the indication form of the second information is not limited by the embodiments of the present disclosure. In addition, the second information is not limited to indicating spatial parameters corresponding to two numbers of transmission layers, but may also be used for indicating spatial parameters corresponding to multiple numbers of transmission layers. For example, the quantity of the number of transmission layers included in the combination of the number of transmission layers indicated by the first information is 3, and the second information may be used for indicating an association order of three numbers of transmission layers and the spatial parameters. For example, when the value of the second information is 0, it is indicated that the first, second and third number of transmission layers are respectively associated with the first, second and third spatial parameters; and when the value of the second information is 1, it is indicated that the first, second and third number of transmission layers are respectively associated with the third, second, and first spatial parameter. Alternatively, a reverse indication manner is used. In an example, the second information may be a separate information field, the second information may be interpreted jointly with the first information, and in a case where the state values or content of the first information are different, the content indicated by the same state value of the second information is different. For example, as shown in Table 2 above, in a case where the state value of the first information is 000, the state value of the second information equals to 1, it is indicated that the number of transmission layers is associated with the first spatial parameter; and in a case where the state value of the first information is 100, the state value of the first information equals to 1, it is indicated that two numbers of transmission layers in the combination of the number of transmission layers are associated with the first spatial parameter and the second spatial parameter, respectively.

Corresponding to PUSCH transmissions based on codebook and PUSCH transmissions based on noncodebook, the indication information may further include other information, and the second information may further indicate other associations. The following introduces the two transmission manners, respectively.

### (1) The PUSCH Transmissions Based on Codebook

Corresponding to the PUSCH transmissions based on codebook, as shown in FIG. 4A, the indication information may further include a first SRS resource indicator and/or a second SRS resource indicator. The first SRS resource indicator is used for indicating one or more SRS resources in a first SRS resource set; and the second SRS resource indicator is used for indicating one or more SRS resources in a second SRS resource set.

In some implementations, a number of SRS ports of an SRS resource configuration indicated by a first SRS resource indicator field is greater than or equal to the number of transmission layers corresponding to the combination of the number of transmission layers.

Accordingly, the second information may further be used for indicating an association relationship of the combination of the number of transmission layers of the at least one uplink channel indicated by the first information with the first SRS resource indicator and/or the second SRS resource indicator.

In some implementations, in a case where a quantity of a number of transmission layers included in the combination of the number of transmission layers indicated by the first information is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator.

For example, in a case where a state value of a part of bits in the first information indicate that the quantity of the number of transmission layers included in the combination of the number of transmission layers is one (as shown in Table 1 above, when the value of the first bit in the first information is 0, it is indicated that one number of transmission layers is included), when the value of the second information is 0, it is indicated that the number of transmission layers is associated with the first SRS resource indicator; and when the value of the second information is 1, it is indicated that the number of transmission layers is associated with the second SRS resource indicator. Alternatively, when the value of the second information is 1, it is indicated that the number of transmission layers is associated with the first SRS resource indicator; and when the value of the second information is 0, it is indicated that the number of transmission layers is associated with the second SRS resource indicator.

In some implementations, in the case where a quantity of a number of transmission layers included in the combination of the number of transmission layers indicated by the first information is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

For example, in a case where a state value of a part of bits in the first information indicate that the quantity of the number of transmission layers included in the combination of the number of transmission layers is multiple (as shown in Table 1 above, when the value of the first bit in the first information is 1, it is indicated that two numbers of transmission layers are included), the second information is used for indicating an association order of the numbers of transmission layers in the combination of the number of transmission layers and the SRS resource indicators. For example, when the value of the second information is 0, it is indicated that the first number of transmission layers and the second number of transmission layers in the combination of the number of transmission layers are associate with the first SRS resource indicator and the second SRS resource indicator, respectively, (that is, the numbers of transmission layers and the SRS resource indicators are associated in a same order); and when the value of the second information is 1, it is indicated that the first number of transmission layers and the second number of transmission layers in the combination of the number of transmission layers are associate with the second SRS resource indicator and the first SRS resource indicator, respectively, (that is, the numbers of transmission layers and the SRS resource indicators are associated in a reverse order), as shown in Table 3. Alternatively, when the value of the second information is 0, it is indicated that the first number of transmission layers and the second number of transmission layers in the combination of the number of transmission layers are associated with the second SRS resource indicator and the first SRS resource indicator, respectively; and when the value of the second information is 1, it is indicated that the first number of transmission layers and the second number of transmission layers in the combination of the number of transmission layers are associated with the first SRS resource indicator and the second SRS resource indicator, respectively.

Table 3 is an indication manner of the second information:

TABLE 3

| State value | | State value of the second |
|---|---|---|
| of the first | The combination of the number of | information and an association |
| information | transmission layers | relationship indicated thereof |
| 000 | A quantity of the number of | The state value equals to 0, it is |
| | transmission layers included in the | indicated that the number of |
| | combination of the number of | transmission layers is associated |
| | transmission layers is one, and the | with the first SRS resource |
| | number of transmission layers is 1 | indicator; and the state |
| | layer | value equals to 1, it is |
| 001 | A quantity of the number of | indicated that the number of |
| | transmission layers included in the | transmission layers is associated |
| | combination of the number of | with the second SRS resource |
| | transmission layers is one, and the | indicator |
| | number of transmission layers is 2 | |
| | layers | |
| 010 | A quantity of the number of | |
| | transmission layers included in the | |
| | combination of the number of | |
| | transmission layers is one, and the | |
| | number of transmission layers is 3 | |
| | layers | |
| 011 | A quantity of the number of | |
| | transmission layers included in the | |
| | combination of the number of | |
| | transmission layers is one, and the | |
| | number of transmission layers is 4 | |
| | layers | |
| 100 | A quantity of the number of | The state value equals to 0, it is |
| | transmission layers included in the | indicated that the two number of |
| | combination of the number of | transmission layers are associated |
| | transmission layers is two, and two | with the first SRS resource indicator |
| | number of transmission layers are 1 | and the second SRS resource |
| | layer and 1 layer, respectively | indicator, respectively; and |
| 101 | A quantity of the number of | the state value equals to 1, it is |
| | transmission layers included in the | indicated that the two number of |
| | combination of the number of | transmission layers are associated |
| | transmission layers is two, and two | with the second SRS resource |
| | number of transmission layers are 2 | indicator and the first SRS resource |
| | layers and 1 layer, respectively | indicator, respectively |
| 110 | A quantity of the number of | |
| | transmission layers included in the | |
| | combination of the number of | |
| | transmission layers is two, and two | |
| | number of transmission layers are 3 | |
| | layers and 1 layer, respectively | |
| 111 | A quantity of the number of | |
| | transmission layers included in the | |
| | combination of the number of | |
| | transmission layers is two, and two | |
| | number of transmission layers are 2 | |
| | layers and 2 layers, respectively | |

Similar to Table 2, Table 3 is also merely an example of that the second information indicates the association relationship between the combination of the number of transmission layers and the SRS resource indicators, and the indication form of the second information is not limited by the embodiments of the present disclosure. In addition, Table 2 and Table 3 may be used for jointly indicating, for example, in the case where the quantity of the number of transmission layers included in the combination of the number of transmission layers indicated by the first information is one, when the value of the second information is 0, it is indicated that the number of transmission layers is associated with the first spatial parameter and the first SRS resource indicator. In an example, the second information may be a separate information field, the second information may be interpreted jointly with the first information, and in a case where the state values or content of the first information are different, the content indicated by a same state value of the second information is different.

Corresponding to the PUSCH transmissions based on codebook, as shown in FIG. 4A, the indication information may further include first precoding information and/or second precoding information.

Accordingly, the second information may further be used to for indicating an association relationship of the combination of the number of transmission layers of the at least one uplink channel indicated by the first information with the first precoding information and/or the second precoding information.

In some implementations, in a case where a quantity of a number of transmission layers included in the combination of the number of transmission layers indicated by the first information is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information.

For example, in a case where a state value of a part of bits in the first information indicate that the quantity of the number of transmission layers included in the combination of the number of transmission layers is one (as shown in Table 1 above, when the value of the first bit in the first information is 0, it is indicated that one number of transmission layers is included), when the value of the second information is 0, it is indicated that the number of transmission layers is associated with the first precoding information; and when the value of the second information is 1, it is indicated that the number of transmission layers is associated with the second precoding information. Alternatively, when the value of the second information is 1, it is indicated that the number of transmission layers is associated with the first precoding information; and when the value of the second information is 0, it is indicated that the number of transmission layers is associated with the second precoding information.

In some implementations, in the case where a quantity of a number of transmission layers included in the combination of the number of transmission layers indicated by the first information is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

For example, in a case where a state value of a part of bits in the first information indicate that the quantity of the number of transmission layers included in the combination of the number of transmission layers is multiple (as shown in Table 1 above, when the value of the first bit in the first information is 1, it is indicated that two number of transmission layers are included), the second information is used for indicating an association order of the numbers of transmission layers in the combination of the number of transmission layers and the precoding information. For example, when the value of the second information is 0, it is indicated that the first number of transmission layers and the second number of transmission layers in the combination of the number of transmission layers are associate with the first precoding information and the second precoding information, respectively, (that is, the numbers of transmission layers and the precoding information are associated in a same order); and when the value of the second information is 1, it is indicated that the first number of transmission layers and the second number of transmission layers in the combination of the number of transmission layers are associate with the second precoding information and the first precoding information, respectively, (that is, the number of transmission layers and the precoding information are associated in a reverse order), as shown in Table 4. Alternatively, when the value of the second information is 0, it is indicated that the first number of transmission layers and the second number of transmission layers in the combination of the number of transmission layers are associated with the second precoding information and the first precoding information, respectively; and when the value of the second information is 1, it is indicated that the first number of transmission layers and the second number of transmission layers in the combination of the number of transmission layers are associated with the first precoding information and the second precoding information, respectively.

Table 4 is an indication manner of the second information:

TABLE 4

| State value | | State value of the second |
|---|---|---|
| of the first | The combination of the number of | information and an association |
| information | transmission layers | relationship indicated thereof |
| 000 | A quantity of the number of | The state value equals to 0, it is |
| | transmission layers included in the | indicated that the number of |
| | combination of the number of | transmission layers is associated |
| | transmission layers is one, and the | with the first precoding information; |
| | number of transmission layers is 1 | and the state value |
| | layer | equals to 1, it is indicated |
| 001 | A quantity of the number of | that the number of |
| | transmission layers included in the | transmission layers is associated |
| | combination of the number of | with the second precoding |
| | transmission layers is one, and the | information |
| | number of transmission layers is 2 | |
| | layers | |
| 010 | A quantity of the number of | |
| | transmission layers included in the | |
| | combination of the number of | |
| | transmission layers is one, and the | |
| | number of transmission layers is 3 | |
| | layers | |
| 011 | A quantity of the number of | |
| | transmission layers included in the | |
| | combination of the number of | |
| | transmission layers is one, and the | |
| | number of transmission layers is 4 | |
| | layers | |
| 100 | A quantity of the number of | The state value equals to 0, it is |
| | transmission layers included in the | indicated that the two number of |
| | combination of the number of | transmission layers are associated |
| | transmission layers is two, and two | with the first precoding information |
| | numbers of transmission layers are | and the second precoding |
| | 1 layer and 1 layer, respectively | information, respectively; and |
| 101 | A quantity of the number of | the state value equals to 1, it is |
| | transmission layers included in the | indicated that the two number of |
| | combination of the number of | transmission layers are associated |
| | transmission layers are two, and | with the second precoding |
| | two numbers of transmission layers | information and the first precoding |
| | are 2 layers and 1 layer, | information, respectively |
| | respectively | |
| 110 | A quantity of the number of | |
| | transmission layers included in the | |
| | combination of the number of | |
| | transmission layers is two, and two | |
| | numbers of transmission layers are | |
| | 3 layers and 1 layer, respectively | |
| 111 | A quantity of the number of | |
| | transmission layers included in the | |
| | combination of the number of | |
| | transmission layers is two, and two | |
| | numbers of transmission layers are | |
| | 2 layers and 2 layers, respectively | |

Similar to Table 2 and Table 3, Table 4 is also merely an example of that the second information indicates the association relationship between the combination of the number of transmission layers and the precoding information, and the indication form of the second information is not limited by the embodiments of the present disclosure. In an example, the second information may be a separate information field, the second information may be interpreted jointly with the first information, and in a case where the state values or content of the first information are different, the content indicated by a same state value of the second information is different. In addition, the content of Tables 2, 3, and 4 may be combined. For example, in the case where the quantity of the number of transmission layers included in the combination of the number of transmission layers indicated by the first information is one, when the value of the second information is 0, it is indicated that the number of transmission layers is associated with the first spatial parameter and the first SRS resource indicator and the first precoding information.

In some implementations, a maximum length of the first precoding information or the second precoding information may be 5 bits.

In some implementations, a set to which values of the first precoding information or the second precoding information belong is associated with a codebook subset type, and the set to which the values of the first precoding information and the second precoding information belong may be associated with a full-power transmission mode. For example, the set to which the values of the first precoding information and the second precoding information belong is presented in a form of a table.

For example, when a number of antenna ports is 4, and the full-power transmission mode is not configured or configured as a full-power transmission mode 2 or full-power transmission mode 0, information indicated by different values of the first precoding information or the second precoding information is shown in Table 5:

TABLE 5

| | Codebook subset = fully | | Codebook subset = | | | |
|---|---|---|---|---|---|---|
| | coheren& partially | | partially coherent & | | Codebook subset = | |
| | coherent & incoherent | | incoherent | | incoherent | |
| | Precoding | | Precoding | | Precoding | |
| | information | | information | | information | |
| | mapping | | mapping | | mapping | |
| | index | TPMI | index | TPMI | index | TPMI |
| The number | 0 | TPMI = 0 | 0 | TPMI = 0 | 0 | TPMI = 0 |
| of | . . . | . . . | . . . | . . . | . . . | . . . |
| transmission | 27 | TPMI = 27 | 11 | TPMI = 11 | 3 | TPMI = 3 |
| layers is 1 | 28 to 31 | Reserved | 12 to 15 | Reserved | 4 to 7 | Reserved |
| layer | | | | | | |
| The number | 0 | TPMI = 0 | 0 | TPMI = 0 | 0 | TPMI = 0 |
| of | . . . | . . . | . . . | . . . | . . . | . . . |
| transmission | 21 | TPMI = 21 | 13 | TPMI = 13 | 5 | TPMI = 5 |
| layers is 2 | 22 to 31 | Reserved | 14 to 15 | Reserved | 6 to 7 | Reserved |
| layers | | | | | | |
| The number | 0 | TPMI = 0 | 0 | TPMI = 0 | 0 | TPMI = 0 |
| of | . . . | . . . | . . . | . . | 1 to 7 | Reserved |
| transmission | 6 | TPMI = 6 | 2 | TPMI = 2 | | |
| layers is 3 | 7 to 31 | 3 layers: | 3 to 15 | Reserved | | |
| layers | | reserved | | | | |
| The number | 0 | TPMI = 0 | 0 | TPMI = 0 | 0 | TPMI = 0 |
| of | . . . | . . . | . . . | . . . | 1 to 7 | Reserved |
| transmission | 4 | TPMI = 4 | 2 | TPMI = 2 | | |
| layers is 4 | 5 to 31 | Reserved | 3 to 15 | Reserved | | |
| layers | | | | | | |

Taking Table 5 as an example, for example, when transmission capabilities reported by the terminal device are supporting fully coherent transmission, partially coherent and incoherent transmission, the length of the first/second precoding information is 5 bits, which may indicate 32 indexes (0 to 31). In a case where a corresponding number of transmission layers is 1 layer, when the first/second precoding information indicates 0, it is indicated that a corresponding transmitted precoding matrix indicator (TPMI) is TPMI=0; when the first/second precoding information indicates 1, it is indicated that the corresponding TPMI=1; until when the first/second precoding information indicates 27, it is indicated that the corresponding TPMI=27; and when the first/second precoding information indicates 28˜31, the indexes are reserved.

As another example, when transmission capabilities reported by the terminal device are to support partially coherent and incoherent transmission, the length of the first/second precoding information is 4 bits, which may indicate 16 indexes (0 to 15). In a case where a corresponding number of transmission layers is 1 layer, when the first/second precoding information indicates 0, it is indicated that a corresponding TPMI=0; when the first/second precoding information indicates 1, it is indicated that the corresponding TPMI=1; until when the first/second precoding information indicates 11, it is indicated that the corresponding TPMI=11; and when the first/second precoding information indicates 12 to 15, the indexes are reserved.

As yet another example, when a transmission capability reported by the terminal device is to support incoherent transmission, corresponding to a case where the number of transmission layers is 1 layer, the length of the first/second precoding information is 3 bits, which may indicate 8 indexes (0 to 7). When the first/second precoding information indicates 0, it is indicated that a corresponding TPMI=0; when the first/second precoding information indicates 1, it is indicated that the corresponding TPMI=1; until when the first/second precoding information indicates 3, it is indicated that the corresponding TPMI=3; and when the first/second precoding information indicates 4 to 7, the indexes are reserved.

For another example, in a case where the number of antenna ports is 4, and the full-power transmission mode is configured as the full-power transmission mode 1, information indicated by different values of the first precoding information or the second precoding information is shown in Table 6A:

TABLE 6A

| | Codebook subset = partially | | Codebook subset = | |
|---|---|---|---|---|
| | coherent & incoherent | | incoherent | |
| | Precoding | | Precoding | |
| | information | | information | |
| | mapping | | mapping | |
| | index | TPMI | index | TPMI |
| The number of | 0 | TPMI = 0 | 0 | TPMI = 0 |
| transmission | . . . | . . . | . . . | . . . |
| layers is 1 | | | 13 | TPMI = 13 |
| layer | 15 | TPMI = 15 | 14 to 15 | Reserved |
| The number of | 0 | TPMI = 0 | 0 | TPMI = 0 |
| transmission | . . . | . . . | . . . | . . . |
| layers is 2 | 13 | TPMI = 13 | 6 | TPMI = 6 |
| layers | 14 to 15 | Reserved | 7 to 15 | Reserved |
| The number of | 0 | TPMI = 0 | 0 | TPMI = 0 |
| transmission | . . . | . . . | 1 | TPMI = 1 |
| layers is 3 | 2 | TPMI = 2 | 2 to 15 | Reserved |
| layers | 3 to 15 | Reserved | | |
| The number of | 0 | TPMI = 0 | 0 | TPMI = 0 |
| transmission | . . . | . . . | 1 to 15 | Reserved |
| layers is 4 | 2 | TPMI = 2 | | |
| layers | 3 to 15 | Reserved | | |

Taking Table 6A as an example, for example, when transmission capabilities reported by the terminal device are to support partially coherent transmission and incoherent transmission, the length of the first/second precoding information is 4 bits, which may indicate 16 indexes (0 to 15). In a case where a corresponding number of transmission layers is 1 layer, when the first/second precoding information indicates 0, it is indicated that a corresponding TPMI=0; when the first/second precoding information indicates 1, it is indicated that the corresponding TPMI=1; until when the first/second precoding information indicates 15, it is indicated that the corresponding TPMI=15.

As another example, when a transmission capability reported by the terminal device is to support incoherent transmission, the length of the first/second precoding information is 4 bits, which may indicate 16 indexes (0 to 15). In a case where a corresponding number of transmission layers is 1 layer, when the first/second precoding information indicates 0, it is indicated that a corresponding TPMI=0; when the first/second precoding information indicates 1, it is indicated that the corresponding TPMI=1; until when the first/second precoding information indicates 13, it is indicated that the corresponding TPMI=13; and when the first/second precoding information indicates 14 to 15, the indexes are reserved.

According to above content indicated by the indication information, the terminal device may perform the PUSCH transmissions based on codebook. For example, if the terminal device receives the indication information, a state value of the first information included in the indication information is 001 and a state value of the second information included in the indication information is 0, combined with Tables 2, 3 and 4 above, the terminal device may determine, according to the first information and the second information, that a quantity of the number of transmission layers included in a combination of the number of transmission layers indicated by the network device is one, the number of transmission layers is 2 layers, and the number of transmission layers is associated with the first spatial parameter, the first SRS resource set, the first SRS resource indicator and the first precoding information. Further combined with the first precoding information carried in the indication information and the aforegoing determined the number of transmission layers, by querying Table 5, the TPMI used for performing the PUSCH transmissions based on codebook may be determined. Finally, the terminal device performs the PUSCH transmissions based on codebook according to determined content.

For another example, in a case where the number of antenna ports is 2, and the full-power transmission mode is not configured or configured as the full-power transmission mode 2 or full-power transmission mode 0, information indicated by different values of the first precoding information or the second precoding information is shown in Table 6B:

TABLE 6B

| | Codebook subset = fully | | | |
|---|---|---|---|---|
| | coherent & partially | | | |
| | coherent & incoherent | | Codebook subset = incoherent | |
| | Precoding | | Precoding | |
| | information | | information | |
| | mapping index | TPMI | mapping index | TPMI |
| The number of | 0 | TPMI = 0 | 0 | TPMI = 0 |
| transmission | 1 | TPMI = 1 | 1 | TPMI = 1 |
| layers is 1 | 2 | TPMI = 2 | | |
| layer | 3 | TPMI = 3 | | |
| | 4 | TPMI = 4 | | |
| | 5 | TPMI = 5 | | |
| | 6 to 7 | Reserved | | |
| The number of | 0 | TPMI = 0 | 0 | TPMI = 0 |
| transmission | 1 | TPMI = 1 | 1 | Reserved |
| layers is 2 | 2 | TPMI = 2 | | |
| layers | 3 to 7 | Reserved | | |

Taking Table 6B as an example, for example, when transmission capabilities reported by the terminal device are to support fully coherent transmission, partially coherent and incoherent transmission, the length of the first/second precoding information is 3 bits, which may indicate 8 indexes (0 to 7). In a case where a corresponding number of transmission layers is 1 layer, when the first/second precoding information indicates 0, it is indicated that a corresponding TPMI=0; and so on, until when the first/second precoding information indicates 5, it is indicated that the corresponding TPMI=5; and when the first/second precoding information indicates 6 or 7, the indexes are reserved.

As another example, when a transmission capability reported by the terminal device is to support incoherent transmission, the length of the first/second precoding information is 1 bit, which may indicate 2 indexes (1 and 2). In a case where a corresponding number of transmission layers is 1 layer, when the first/second precoding information indicates 0, it is indicated that the corresponding TPMI=0; when the first/second precoding information indicates 1, it is indicated that the corresponding TPMI=1.

For another example, in a case where the number of antenna ports is 2, and the full-power transmission mode is configured as the full-power transmission mode 1, information indicated by different values of the first precoding information or the second precoding information is shown in Table 6C:

TABLE 6C

| | Codebook subset = incoherent | |
|---|---|---|
| | Precoding | |
| | information | |
| | mapping index | TPMI |
| The number of | 0 | TPMI = 0 |
| transmission | 1 | TPMI = 1 |
| layers is 1 layer | 2 | TPMI = 2 |
| | 3 | Reserved |
| The number of | 0 | TPMI = 0 |
| transmission | 1 to 3 | Reserved |
| layers is 2 | | |
| layers | | |

Taking Table 6C as an example, for example, when a transmission capability reported by the terminal device is to support incoherent transmission, the length of the first/second precoding information is 2 bits, which may indicate 4 indexes (0 to 3). In a case where a corresponding number of transmission layers is 1 layer, when the first/second precoding information indicates 0, it is indicated that a corresponding TPMI=0; and so on, until when the first/second precoding information indicates 2, it is indicated that the corresponding TPMI=2; and when the first/second precoding information indicates 3, the index is reserved.

### (2) The PUSCH Transmissions Based on Noncodebook

FIG. 4B is a schematic diagram of a second example of interactions between a terminal device and a network device. Corresponding to the PUSCH transmissions based on noncodebook, as shown in FIG. 4B, the indication information may include first information, second information, a first SRS resource indicator and a second SRS resource indicator. The content of the first information is same as the content of the first information in the examples of the PUSCH transmissions based on codebook, which will not be repeated here. The second information may indicate an association relationship between a combination of a number of transmission layers indicated by the first information and a spatial parameter, as in the examples shown in Table 2 above. The second information may further indicate an association relationship between the combination of the number of transmission layers indicated by the first information and the SRS resource indicator, as in the examples shown in Table 3 above. Similar to the examples of the PUSCH transmissions based on codebook, in the PUSCH transmissions based on noncodebook, Tables 2 and 3 may also be combined, such as, in the case where the quantity of the number of transmission layers included in the combination of the number of transmission layers indicated by the first information is one, when a value of the second information is 0, it is indicated that the number of transmission layers is associated with the first spatial parameter and the first SRS resource indicator.

For example, a set to which values of the first SRS resource indicator and second SRS resource indicator belong is presented in a form of a table.

Exemplarily, information indicated by different values of the first SRS resource indicator or the second SRS resource indicator is shown in Table 7:

TABLE 7

| | A number of SRS | | A number of SRS | | A number of SRS | |
|---|---|---|---|---|---|---|
| | resources in a SRS | | resources in a SRS | | resources in a SRS | |
| | resource set is 2 | | resource set is 3 | | resource set is 4 | |
| | SRS | | SRS | | SRS | |
| | resource | | resource | | resource | |
| | indicator | SRS | indicator | SRS | indicator | SRS |
| | mapping | resource | mapping | resource | mapping | resource |
| | index | index | index | index | index | index |
| The number | 0 | 0 | 0 | 0 | 0 | 0 |
| of | 1 | 1 | 1 | 1 | 1 | 1 |
| transmission | | | 2 | 2 | 2 | 2 |
| layers is 1 | | | 3 | Reserved | 3 | 3 |
| layer | | | | | 4 to 7 | Reserved |
| The number | 0 | 0, 1 | 0 | 0, 1 | 0 | 0, 1 |
| of | 1 | Reserved | 1 | 0, 2 | 1 | 0, 2 |
| transmission | | | 2 | 1, 2 | 2 | 0, 3 |
| layers is 2 | | | 3 | Reserved | 3 | 1, 2 |
| layers | | | | | 4 | 1, 3 |
| | | | | | 5 | 2, 3 |
| | | | | | 6 to 7 | Reserved |
| The number | | | 0 | 0, 1, 2 | 0 | 0, 1, 2 |
| of | | | 1 to 3 | Reserved | 1 | 0, 1, 3 |
| transmission | | | | | 2 | 0, 2, 3 |
| layers is 3 | | | | | 3 | 1, 2, 3 |
| layers | | | | | 4 to 7 | Reserved |
| The number | | | | | 0 | 0, 1, 2, 3 |
| of | | | | | 1 to 7 | Reserved |
| transmission | | | | | | |
| layers has 4 | | | | | | |
| layers | | | | | | |

Taking Table 7 as an example, for example, in a case where the number of transmission layers has 1 layer, if the number of SRS resources in the SRS resource set is 2, the length of the first/second SRS resource indicator may be 1 bit, and 2 possible values of the first/second SRS resource indicator are used to indicate SRS resource indexes in the SRS resource set. As shown in Table 7, in the case where the number of transmission layers is 1 layer, when a state value of the first/second SRS resource indicator is 0, an SRS resource 0 in the first/second SRS resource set is indicated; and when the state value of the first/second SRS resource indicator is 1, an SRS resource 1 in the first/second SRS resource set is indicated. For another example, in a case where the number of transmission layers is 2 layers, if the number of SRS resources in the SRS resource set is 3, in order to indicate any two SRS resources in the SRS resource set (there are a total of 3 cases), the length of the first/second SRS resource indicator may be 2 bits. As shown in Table 7, in the case where the number of transmission layers is 2 layers, when the state value of the first/second SRS resource indicator is 0, the SRS resource 0 and SRS resource 1 in the first/second SRS resource set are indicated; when the state value of the first/second SRS resource indicator is 1, the SRS resource 0 and SRS resource 2 in the first/second SRS resource set are indicated; and when the state value of the first/second SRS resource indicator is 2, the SRS resource 1 and SRS resource 2 in the first/second SRS resource set are indicated.

After receiving the indication information, the terminal device may determine, according to the first information, the second information and the first/second SRS resource indicator in the indication information, the combination of the number of transmission layers, the spatial parameter and SRS resource indicator corresponding to each number of transmission layers, or the like, and determine the SRS resource corresponding to each number of transmission layers according to the SRS resource indicator, so that the PUSCH transmissions based on noncodebook is performed according to determined content.

For example, in a case where a state value of the first information is 001 and a state value of the second information is 0, the terminal device may determine that there is only one number of transmission layers is included in the combination of the number of transmission layers according to the first information and the second information, in which the number of transmission layers is 2 layers, and the number of transmission layers is associated with the first SRS resource set and the first SRS resource indicator. Assuming that the first SRS resource set configured by the network device for the terminal device in advance includes 4 SRS resources, and a state value of the first SRS resource indicator in the indication information is “010”, a mapping index of the first SRS resource indicator is 2. Table 7 is queried according to the mapping index of the first SRS resource indicator and the number of SRS resources in the first SRS resource set, to determine that SRS resources corresponding to the number of transmission layers are the SRS resource 0 and SRS resource 3 in the first SRS resource set.

For another example, in a case where a state value of the first information is 101 and a state value of the second information is 0, the terminal device may determine that there are two numbers of transmission layers included in the combination of the number of transmission layers according to the first information and the second information, in which the two numbers of transmission layers are 2 layers and 1 layer, respectively, and the 2 layers in the combination of the number of transmission layers is associated with the first SRS resource set and the first SRS resource indicator, and the 1 layer in the combination of the number of transmission layers is associated with the second SRS resource set and the second SRS resource indicator. Further, an SRS resource corresponding to each number of transmission layers is determined according to the first SRS resource indicator and second SRS resource indicator.

The implementations of indicating the combination of the number of transmission layers of the uplink channel and the association relationship between the combination of the number of transmission layers of the at least one uplink channel and the spatial parameter are respectively introduced above. Through the way of indicating the combination of the number of transmission layers by the first information, and indicating the association relationship between the number of transmission layers and the spatial parameter by combining with the first information indicating a quantity of elements of the number of transmission layers and the second information, the number of bits of the second information may be reduced. In addition, the second information may also indicate the association relationships of the combination of the number of transmission layers with the precoding information and SRS resource indicator (SRI). The first information may be used for a transmission of a single panel/TRP when indicating one number of transmission layers, in this case, the second information may be used for indicating a panel/TRP used by the number of transmission layers. The first information may be used for a transmission of multiple panels/TRPs when indicating multiple numbers of transmission layers, in this case, the second information may be used for a mapping order of the multiple numbers of transmission layers and spatial parameters.

### Manner Two

A combination of a number of transmission layers of at least one uplink channel and an association relationship between the combination of the number of transmission layers of the at least one uplink channel and a spatial parameter are jointly indicated.

For example, the indication information includes third information, and the third information is used for indicating the combination of the number of transmission layers of the at least one uplink channel and the association relationship between the combination of the number of transmission layers of the at least one uplink channel and a spatial parameter.

The present embodiments proposes at least the following two joint indication manners:

### Joint Indication Manner One

For example, m1 first bits in the third information indicate a number of transmission layers associated with a first spatial parameter in the combination of the number of transmission layers of the at least one uplink channel;
m2 second bits in the third information indicate a number of transmission layers associated with a second spatial parameter in the combination of the number of transmission layers of the at least one uplink channel; where
m1 and m2 are positive integers.

In some implementations, the first bits are most significant bits (MSBs) and the second bits are least significant bits (LSBs); or the first bits are LSBs and the second bits are MSBs.

Table 8-1 is an example of an indication manner of the third information:

TABLE 8-1

| | | | The number of |
|---|---|---|---|
| | The number of | | transmission layers |
| | transmission layers | | associated with the |
| | associated with the | | second spatial |
| | first spatial parameter | | parameter in the |
| | in the combination of | | combination of the |
| | the number of | | number of |
| MSB | transmission layers | LSB | transmission layers |
| 00 | 1 layer | 00 | 1 layer |
| 01 | 2 layers | 01 | 2 layers |
| 10 | 3 layers | 10 | 3 layers |
| 11 | 4 layers | 11 | 4 layers |

Taking Table 8-1 as an example, for a case where there are two numbers of transmission layers are included in the combination of the number of transmission layers and each number of transmission layers is no more than 4 layers, a length of the third information may be 4 bits, where first 2 bits (i.e., the most significant bits) indicate the number of transmission layers associated with the first spatial parameter in the combination of the number of the transmission layers, and last 2 bits (i.e., the least significant bits) indicate the number of transmission layers associated with the second spatial parameter in the combination of the number of the transmission layers. For example, the third information is 0001, and it is indicated that there are two numbers of transmission layers, which are 1 layer and 2 layers, respectively, where the 1 layer is associated with the first spatial parameter and the 2 layers are associated with the second spatial parameter.

Table 8-2 is another example of an indication manner of the third information:

TABLE 8-2

| | The number of transmission |
|---|---|
| | layers included in the |
| | combination of the number of |
| | transmission layers (only one |
| | number of transmission |
| Third | layers is included in the |
| information | combination) |
| 00 | 1 layer |
| 01 | 2 layers |
| 10 | 3 layers |
| 11 | 4 layers |

Taking Table 8-2 as an example, for a case where there is one number of transmission layers included in the combination of the number of transmission layers and the number of transmission layers is no more than 4 layers, a length of the third information may be 2 bits, which is used to indicate 4 cases of the combination of the number of transmission layers.

### Joint Indication Manner Two

For example, k1 state values of the third information indicate a number of transmission layers associated with a first spatial parameter;
k2 state values of the third information indicate a number of transmission layers associated with a second spatial parameter; and
k3 state values of the third information indicate a number of transmission layers associated with a first spatial parameter and a number of transmission layers associated with a second spatial parameter, respectively; where
k1, k2 and k3 are positive integers.

Table 8-3 is another example of an indication manner of the third information:

TABLE 8-3

| | | The association relationship |
|---|---|---|
| | | between the combination of the |
| Third | The combination of the | number of transmission layers and |
| information | number of transmission layers | the spatial parameter |
| 0000 | The combination of the number of | Implicitly associated with the first |
| | transmission layers includes 1 layer | spatial parameter |
| | and 0 layers | |
| 0001 | The combination of the number of | Implicitly associated with the first |
| | transmission layers includes 2 | spatial parameter |
| | layers and 0 layers | |
| 0010 | The combination of the number of | Implicitly associated with the first |
| | transmission layers includes 3 | spatial parameter |
| | layers and 0 layers | |
| 0011 | The combination of the number of | Implicitly associated with the first |
| | transmission layers includes 4 | spatial parameter |
| | layers and 0 layers | |
| 0100 | The combination of the number of | Associated with the first spatial |
| | transmission layers includes 2 | parameter and the second spatial |
| | layers and 1 layer | parameter, respectively |
| 0101 | The combination of the number of | Associated with the first spatial |
| | transmission layers includes 3 | parameter and the second spatial |
| | layers and 1 layer | parameter, respectively |
| 0110 | The combination of the number of | Implicitly associated with the first |
| | transmission layers includes 1 layer | and second spatial parameters, |
| | and 1 layer | respectively; or implicitly |
| | | associated with the second and first |
| | | spatial parameters, respectively |
| 0111 | The combination of the number of | Implicitly associated with the first |
| | transmission layers includes 2 | and second spatial parameters, |
| | layers and 2 layers | respectively; or implicitly |
| | | associated with the second and first |
| | | spatial parameters, respectively |
| 1000 | The combination of the number of | Implicitly associated with the |
| | transmission layers includes 0 | second spatial parameter |
| | layers and 1 layer | |
| 1001 | The combination of the number of | Implicitly associated with the |
| | transmission layers includes 0 | second spatial parameter |
| | layers and 2 layers | |
| 1010 | The combination of the number of | Implicitly associated with the |
| | transmission layers includes 0 | second spatial parameter |
| | layers and 3 layers | |
| 1011 | The combination of the number of | Implicitly associated with the |
| | transmission layers includes 0 | second spatial parameter |
| | layers and 4 layers | |
| 1100 | The combination of the number of | Associated with the first spatial |
| | transmission layers includes 1 layer | parameter and the second spatial |
| | and 2 layers | parameter, respectively |
| 1101 | The combination of the number of | Associated with the first spatial |
| | transmission layers includes 1 layer | parameter and the second spatial |
| | and 3 layers | parameter, respectively |
| 1110 | Reserved | |
| 1111 | Reserved | |

Taking Table 8-3 as an example, 4 state values (i.e., k1=4) of 0000, 0001, 0010, 0011 of the third information respectively indicate numbers of transmission layers associated with the first spatial parameter, 4 state values (i.e., k2=4) of 1000, 1001, 1010, 1011 respectively indicate numbers of transmission layers associated with the second spatial parameter, and 6 state values (i.e., k3=3) of 0100, 0101, 0110, 0111, 1100, 1101 respectively indicate the number of transmission layers associated with the first spatial parameter and the second spatial parameter. The third information jointly indicates the combination of the number of transmission layers and the association relationship between the number of transmission layers and the spatial parameter, and indicates the precoding information and SRI by means of an implicit mapping. The first information may be used for a transmission of a single panel/TRP when one element is included in the first information, in this case, which may be used for indicating a used panel/TRP. The first information may be used for a transmission of multiple panels/TRPs when multiple elements are included in the first information, in this case, which may be used for a mapping order of the number of transmission layers and the spatial parameter.

Corresponding to the PUSCH transmissions based on codebook and PUSCH transmissions based on noncodebook, the indication information may further include other information, and the third information may further indicate other association relationships.

### (1) The PUSCH Transmissions Based on Codebook

FIG. 4C is a schematic diagram of a third example of interactions between a terminal device and a network device. Corresponding to the PUSCH transmissions based on codebook, the indication information includes third information, and may further include a first SRS resource indicator and/or a second SRS resource indicator. Where the first SRS resource indicator is used for indicating one or more SRS resources in a first SRS resource set; and the second SRS resource indicator is used for indicating one or more SRS resources in a second SRS resource set.

In some implementations, a number of SRS ports of an SRS resource configuration indicated by a first SRS resource indicator field is greater than or equal to a corresponding number of transmission layers in the combination of the number of transmission layers.

Accordingly, the third information may further be used for indicating an association relationship of the combination of the number of transmission layers of the at least one uplink channel with the first SRS resource indicator and/or the second SRS resource indicator.

In addition, as shown in FIG. 4C, the indication information may further include first precoding information and/or second precoding information.

Accordingly, the third information may further be used for indicating an association relationship of the combination of the number of transmission layers of the at least one uplink channel with the first precoding information and/or the second precoding information.

Content indicated by different state values of the first/second precoding information are same as corresponding content of the above respective indication manners, which will not be repeated here.

According to the content indicated in the indication information, the terminal device may perform PUSCH transmissions based on codebook, and the specific manners are same as the corresponding content of the above respective indication manners, which will not be repeated here.

### (2) The PUSCH Transmissions Based on Noncodebook

FIG. 4D is a schematic diagram of a fourth example of interactions between a terminal device and a network device. As shown in FIG. 4D, corresponding to the PUSCH transmissions based on codebook, the indication information includes third information, and may further include a first SRS resource indicator and/or a second SRS resource indicator. Where the first SRS resource indicator is used for indicating one or more SRS resources in a first SRS resource set; and the second SRS resource indicator is used for indicating one or more SRS resources in a second SRS resource set.

In some implementations, a number of SRS ports of an SRS resource configuration indicated by a first SRS resource indicator field is greater than or equal to a corresponding number of transmission layers in the combination of the number of transmission layers.

Accordingly, the third information may further be used for indicating an association relationship of the combination of the number of transmission layers of the at least one uplink channel with the first SRS resource indicator and/or the second SRS resource indicator.

Content indicated by different state values of the first/second SRS resource indicator are same as corresponding content of the above respective indication manners, which will not be repeated here.

According to the content indicated in the indication information, the terminal device may perform PUSCH transmissions based on noncodebook, and the specific manners are same as the corresponding content in the above respective indication manners, which will not be repeated here.

The embodiments of the present disclosure further provide an indication method, and FIG. 5 is a schematic flowchart of an indication method 500 according to an embodiment of the present disclosure. Optionally, the method may be applied to the system shown in FIG. 1, but is not limited thereto. The method includes at least part of the following content.

S510, a network device transmits indication information, where the indication information is used for indicating a combination of a number of transmission layers of at least one uplink channel.

In an implementation, each uplink channel is associated with a spatial parameter, and the spatial parameter includes at least one of: transmission configuration indicator (TCI) state information, capability set information, antenna panel information, transmission reception point (TRP) information, control resource set (CORESET) information, reference signal set information, an SRS resource set, reference signal information, or beam information.

In the embodiments of the present disclosure, the combination of the number of transmission layers of the at least one uplink channel, and an association relationship between the combination of the number of transmission layers of the at least one uplink channel and a spatial parameter may be respectively indicated.

For example, in an implementation, the indication information includes first information, and the first information is used for indicating the combination of the number of transmission layers of the at least one uplink channel.

In an implementation, the indication information further includes second information, and the second information is used for indicating the association relationship between the combination of the number of transmission layers of the at least one uplink channel and the spatial parameter.

In the embodiments of the present disclosure, a quantity of a number of transmission layers included in the combination of the number of transmission layers may be determined according to a state value of a first bit. For example, when a value of the first bit is 0, it is indicated that a quantity of an element in the combination of the number of transmission layers is 1; and when the value of the first bit is 1, it is indicated that the quantity of elements in the combination of the number of transmission layers is 2.

In an implementation, in a case where a quantity of a number of transmission layers included in the combination of the number of transmission layers of the at least one uplink channel is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter.

In an implementation, in a case where a quantity of a number of transmission layers included in the combination of the number of transmission layers of the at least one uplink channel is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

In an implementation, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

Accordingly, in an implementation, the second information is further used for indicating an association relationship of the combination of the number of transmission layers of the at least one uplink channel with the first SRS resource indicator and/or the second SRS resource indicator.

In an implementation, in a case where a quantity of a number of transmission layers included in the combination of the number of transmission layers of the at least one uplink channel is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator.

In an implementation, in a case where a quantity of a number of transmission layers included in the combination of the number of transmission layers of the at least one uplink channel is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

In an implementation, the indication information further includes first precoding information and/or second precoding information.

Accordingly, in an implementation, the second information is further used for indicating an association relationship of the combination of the number of transmission layers of the at least one uplink channel with the first precoding information and/or the second precoding information.

In an implementation, in a case where a quantity of a number of transmission layers included in the combination of the number of transmission layers of the at least one uplink channel is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information.

In an implementation, in a case where a quantity of a number of transmission layers included in the combination of the number of transmission layers of the at least one uplink channel is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

In the embodiments of the present disclosure the combination of the number of transmission layers of the at least one uplink channel and an association relationship between the combination of the number of transmission layers of the at least one uplink channel and a spatial parameter may further be jointly indicated.

For example, in an implementation, the indication information includes third information, and the third information is used for indicating the combination of the number of transmission layers of the at least one uplink channel and the association relationship between the combination of the number of transmission layers of the at least one uplink channel and the spatial parameter.

In an implementation, m1 first bits in the third information indicate a number of transmission layers associated with a first spatial parameter in the combination of the number of transmission layers of the at least one uplink channel; and
m2 second bits in the third information indicate a number of transmission layers associated with a second spatial parameter in the combination of the number of transmission layers of the at least one uplink channel; where
m1 and m2 are positive integers.

By using the above manner, in the embodiments of the present disclosure, each number of transmission layers in the combination of the number of transmission layers may be indicated, and the association relationship between each number of transmission layers and a corresponding spatial parameter is implicitly indicated.

In an implementation, the first bits are most significant bits (MSBs) and the second bits are least significant bits (LSBs); or the first bits are LSBs and the second bits are MSBs.

In an implementation, k1 state values of the third information indicate a number of transmission layers associated with a first spatial parameter;
k2 state values of the third information indicate a number of transmission layers associated with a second spatial parameter; and
k3 state values of the third information indicate a number of transmission layers associated with a first spatial parameter and a number of transmission layers associated with a second spatial parameter, respectively; where
k1, k2 and k3 are positive integers.

In an implementation, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In an implementation, the third information is further used for indicating an association relationship of the combination of the number of transmission layers of the at least one uplink channel with the first SRS resource indicator and/or the second SRS resource indicator.

In an implementation, a number of SRS ports of an SRS resource configuration indicated by the first SRS resource indicator and/or the second SRS resource indicator is greater than or equal to a number of associated transmission layers.

In an implementation, the indication information further includes first precoding information and/or second precoding information.

Accordingly, in an implementation, the third information is further used for indicating an association relationship of the combination of the number of transmission layers of the at least one uplink channel with the first precoding information and/or the second precoding information.

In an implementation, the indication method provided by the embodiments of the present disclosure may further include: receiving, by the network device, the at least one uplink channel transmitted according to the indication information.

In an implementation, a quantity of a number of transmission layers in the combination of the number of transmission layers of the at least one uplink channel is associated with a capability of a terminal device.

In an implementation, the quantity of the number of transmission layers in the combination of the number of transmission layers of the at least one uplink channel being associated with the capability of the terminal device includes:
in a case where the terminal device supports simultaneous transmission of multi-antenna panels, the quantity of the number of transmission layers included in the combination of the number of transmission layers of the at least one uplink channel being multiple; or
in a case where the terminal device does not support simultaneous transmission of multi-antenna panels, the quantity of the number of transmission layers included in the combination of the number of transmission layers of the at least one uplink channel being one.

In an implementation, a sum of layers of a number of transmission layers in the combination of the number of transmission layers of the at least one uplink channel is less than or equal to a maximum number of transmission layers supported by a terminal device.

In an implementation, the maximum number of transmission layers includes:
a maximum number of transmission layers supported by the terminal device on an uplink channel associated with multiple spatial parameters; or
a sum of a maximum number of transmission layers supported by the terminal device on an uplink channel associated with each spatial parameter; or
a maximum number of transmission layers supported by the terminal device.

In an implementation, each number of transmission layers in the combination of the number of transmission layers of the at least one uplink channel is less than or equal to a maximum number of transmission layers supported by the terminal device on an uplink channel associated with a corresponding spatial parameter.

Specific examples of the method 500 performed by the network device of the present embodiments may be refer to relevant descriptions related to the network device in the above method 200, which will not be repeated here for the sake of brevity.

FIG. 6 is a schematic block diagram of a terminal device 600 according to an embodiment of the present disclosure. The terminal device 600 may include:
a first receiving module 610, configured to receive indication information, the indication information being used for indicating a combination of a number of transmission layers of at least one uplink channel.

In some implementations, each uplink channel is associated with a spatial parameter, and the spatial parameter includes at least one of: transmission configuration indicator (TCI) state information, capability set information, antenna panel information, transmission reception point (TRP) information, control resource set (CORESET) information, reference signal set information, an SRS resource set, reference signal information, or beam information.

In some implementations, the indication information includes first information, and the first information is used for indicating the combination of the number of transmission layers of the at least one uplink channel.

In some implementations, the indication information further includes second information, and the second information is used for indicating an association relationship between the combination of the number of transmission layers of the at least one uplink channel and a spatial parameter.

In some implementations, in a case where a quantity of a number of transmission layers included in the combination of the number of transmission layers of the at least one uplink channel is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter.

In some implementations, in a case where a quantity of a number of transmission layers included in the combination of the number of transmission layers of the at least one uplink channel is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

In some implementations, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some implementations, the second information is further used for indicating an association relationship of the combination of the number of transmission layers of the at least one uplink channel with the first SRS resource indicator and/or the second SRS resource indicator.

In some implementations, in a case where a quantity of a number of transmission layers included in the combination of the number of transmission layers of the at least one uplink channel is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator.

In some implementations, in a case where a quantity of a number of transmission layers included in the combination of the number of transmission layers of the at least one uplink channel is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

In some implementations, the indication information further includes first precoding information and/or second precoding information.

In some implementations, the second information is further used for indicating an association relationship of the combination of the number of transmission layers of the at least one uplink channel with the first precoding information and/or the second precoding information.

In some implementations, in a case where a quantity of a number of transmission layers included in the combination of the number of transmission layers of the at least one uplink channel is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information.

In some implementations, in a case where a quantity of a number of transmission layers included in the combination of the number of transmission layers of the at least one uplink channel is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

In some implementations, the indication information includes third information, and the third information is used for indicating the combination of the number of transmission layers of the at least one uplink channel and an association relationship between the combination of the number of transmission layers of the at least one uplink channel and a spatial parameter.

In some implementations, m1 first bits in the third information indicate a number of transmission layers associated with a first spatial parameter in the combination of the number of transmission layers of the at least one uplink channel; and
m2 second bits in the third information indicate a number of transmission layers associated with a second spatial parameter in the combination of the number of transmission layers of the at least one uplink channel; where
m1 and m2 are positive integers.

In some implementations, the first bits are most significant bits (MSBs) and the second bits are least significant bits (LSBs); or
the first bits are LSBs and the second bits are MSBs.

In some implementations, k1 state values of the third information indicate a number of transmission layers associated with a first spatial parameter;
k2 state values of the third information indicate a number of transmission layers associated with a second spatial parameter; and
k3 state values of the third information indicate a number of transmission layers associated with a first spatial parameter and a number of transmission layers associated with a second spatial parameter, respectively; where
k1, k2 and k3 are positive integers.

In some implementations, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some implementations, the third information is further used for indicating an association relationship of the combination of the number of transmission layers of the at least one uplink channel with the first SRS resource indicator and/or the second SRS resource indicator.

In some implementations, a number of SRS ports of an SRS resource configuration indicated by the first SRS resource indicator and/or the second SRS resource indicator is greater than or equal to a number of associated transmission layers.

In some implementations, the indication information further includes first precoding information and/or second precoding information.

In some implementations, the third information is further used for indicating an association relationship of the combination of the number of transmission layers of the at least one uplink channel with the first precoding information and/or the second precoding information.

FIG. 7 is a schematic block diagram of a terminal device 700 according to an embodiment of the present disclosure. As shown in FIG. 7, in some implementations, the terminal device 700 may further include:
a first transmitting module 720, configured to transmit at least one uplink channel according to the indication information.

In some implementations, the first transmitting module 720 is configured to determine, according to the indication information, at least one of the following:
the number of transmission layers of the at least one uplink channel;
a spatial parameter associated with a number of transmission layers of each uplink channel;
an SRS resource indicator associated with a number of transmission layers of each uplink channel; or
precoding information associated with a number of transmission layers of each uplink channel; and
transmit an uplink channel according to determined content.

The terminal device transmits the uplink channel by using the number of transmission layers of the at least one uplink channel, and the spatial parameter and precoding information associated with the number of transmission layers of each of the at least uplink channel. In some implementations, the first transmitting module 720 is configured to:
determine, according to the indication information, at least one of the following:
the number of transmission layers of the at least one uplink channel;
a spatial parameter associated with a number of transmission layers of each uplink channel; or
an SRS resource indicator associated with a number of transmission layers of each uplink channel; and
transmit an uplink channel according to determined content.

The terminal device transmits the uplink channel by using the number of transmission layers of the at least one uplink channel, and the spatial parameter and SRS resource indicator associated with the number of transmission layers of each uplink channel.

In some implementations, a quantity of the number of transmission layers in the combination of the number of transmission layers of the at least one uplink channel is associated with a capability of the terminal device.

In some implementations, in a case where the terminal device supports simultaneous transmission of multi-antenna panels, the quantity of the number of transmission layers included in the combination of the number of transmission layers of the at least one uplink channel is multiple, or
in a case where the terminal device does not support simultaneous transmission of multi-antenna panels, the quantity of the number of transmission layers included in the combination of the number of transmission layers of the at least one uplink channel is one.

In some implementations, a sum of layers of number of transmission layers in the combination of the number of transmission layers of the at least one uplink channel is less than or equal to a maximum number of transmission layers supported by the terminal device.

In some implementations, the maximum number of transmission layers includes:
a maximum number of transmission layers supported by the terminal device on an uplink channel associated with multiple spatial parameters; or
a sum of a maximum number of transmission layers supported by the terminal device on an uplink channel associated with each spatial parameter; or
a maximum number of transmission layers supported by the terminal device.

In some implementations, each number of transmission layers in the combination of the number of transmission layers of the at least one uplink channel is less than or equal to a maximum number of transmission layers supported by the terminal device on an uplink channel associated with a corresponding spatial parameter.

The terminal devices 600 and 700 of the embodiments of the present disclosure may realize corresponding functions of the terminal device in the above method embodiments. Processes, functions, implementations and beneficial effects corresponding to each module (submodule, unit, component, or the like) of the terminal devices 600 and 700 may be referred to the corresponding description in the above method embodiments, which will not be repeated here. It should be noted that the functions described with respect to each module (submodule, unit, component, or the like) in the terminal devices 600 and 700 of the embodiments of the present disclosure may be implemented by different modules (submodules, units, components, or the like), or may be implemented by the same module (submodule, unit, component, or the like).

FIG. 8 is a schematic block diagram of a network device 800 according to an embodiment of the present disclosure. The network device 800 may include:
a second transmitting module 810, configured to transmit indication information, the indication information being used for indicating a combination of a number of transmission layers of at least one uplink channel.

In some implementations, each uplink channel is associated with a spatial parameter, and the spatial parameter includes at least one of: transmission configuration indicator (TCI) state information, capability set information, antenna panel information, transmission reception point (TRP) information, control resource set (CORESET) information, reference signal set information, an SRS resource set, reference signal information, or beam information.

In some implementations, the indication information includes first information, and the first information is used for indicating the combination of the number of transmission layers of the at least one uplink channel.

In some implementations, the indication information further includes second information, and the second information is used for indicating an association relationship between the combination of the number of transmission layers of the at least one uplink channel and a spatial parameter.

In some implementations, in a case where a quantity of a number of transmission layers included in the combination of the number of transmission layers of the at least one uplink channel is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter.

In some implementations, in a case where a quantity of a number of transmission layers included in the combination of the number of transmission layers of the at least one uplink channel is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

In some implementations, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some implementations, second information is further used for indicating an association relationship of the combination of the number of transmission layers of the at least one uplink channel with the first SRS resource indicator and/or the second SRS resource indicator.

In some implementations, in a case where a quantity of a number of transmission layers included in the combination of the number of transmission layers of the at least one uplink channel is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator.

In some implementations, in a case where a quantity of a number of transmission layers co included in the combination of the number of transmission layers of the at least one uplink channel is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

In some implementations, the indication information further includes first precoding information and/or second precoding information.

In some implementations, the second information is further used for indicating an association relationship of the combination of the number of transmission layers of the at least one uplink channel with the first precoding information and/or the second precoding information.

In some implementations, in a case where a quantity of a number of transmission layers included in the combination of the number of transmission layers of the at least one uplink channel is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information.

In some implementations, in a case where a quantity of a number of transmission layers included in the combination of the number of transmission layers of the at least one uplink channel is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

In some implementations, the indication information includes third information, and the third information is used for indicating the combination of the number of transmission layers of the at least one uplink channel and an association relationship between the combination of the number of transmission layers of the at least one uplink channel and a spatial parameter.

In some implementations, m1 first bits in the third information indicate a number of transmission layers associated with a first spatial parameter in the combination of the number of transmission layers of the at least one uplink channel; and
m2 second bits in the third information indicate a number of transmission layers associated with a second spatial parameter in the combination of the number of transmission layers of the at least one uplink channel; where
m1 and m2 are positive integers.

In some implementations, the first bits are most significant bits (MSBs) and the second bits are least significant bits (LSBs); or
the first bits are LSBs and the second bits are MSBs.

In some implementations, k1 state values of the third information indicate a number of transmission layers associated with a first spatial parameter;
k2 state values of the third information indicate a number of transmission layers associated with a second spatial parameter; and
k3 state values of the third information indicate a number of transmission layers associated with a first spatial parameter and a number of transmission layers associated with a second spatial parameter, respectively; where
k1, k2 and k3 are positive integers.

In some implementations, the indication information further includes a first SRS resource indicator and/or a second SRS resource indicator; where
the first SRS resource indicator is used for indicating one or more SRS resources in a first SRS resource set; and
the second SRS resource indicator is used for indicating one or more SRS resources in a second SRS resource set.

In some implementations, the third information is further used for indicating an association relationship of the combination of the number of transmission layers of the at least one uplink channel with the first SRS resource indicator and/or the second SRS resource indicator.

In some implementations, a number of SRS ports of an SRS resource configuration indicated by the first SRS resource indicator and/or the second SRS resource indicator is greater than or equal to a number of associated transmission layers.

In some implementations, the indication information further includes first precoding information and/or second precoding information.

In some implementations, the third information is further used for indicating an association relationship of the combination of the number of transmission layers of the at least one uplink channel with the first precoding information and/or the second precoding information.

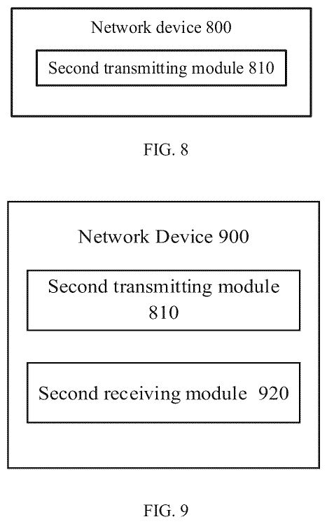

FIG. 9 is a schematic block diagram of a network device 900 according to an embodiment of the present disclosure. As shown in FIG. 9, in some embodiments, the network device 900 may further include:
a second receiving module 920, configure to receive the at least one uplink channel transmitted according to the indication information.

In some implementations, a quantity of a number of transmission layers in the combination of the number of transmission layers of the at least one uplink channel is associated with a capability of a terminal device.

In some implementations, in a case where the terminal device supports simultaneous transmission of multi-antenna panels, the quantity of the number of transmission layers included in the combination of the number of transmission layers of the at least one uplink channel is multiple; or
in a case where the terminal device does not support simultaneous transmission of multi-antenna panels, the quantity of the number of transmission layers included in the combination of the number of transmission layers of the at least one uplink channel is one.

In some implementations, a sum of layers of number of transmission layers in the combination of the number of transmission layers of the at least one uplink channel is less than or equal to a maximum number of transmission layers supported by a terminal device.

In some implementations, the maximum number of transmission layers includes:
a maximum number of transmission layers supported by the terminal device on an uplink channel associated with multiple spatial parameters; or
a sum of a maximum number of transmission layers supported by the terminal device on an uplink channel associated with each spatial parameter; or
a maximum number of transmission layers supported by the terminal device.

In some implementations, each number of transmission layers in the combination of the number of transmission layers of the at least one uplink channel is less than or equal to a maximum number of transmission layers supported by the terminal device on the uplink channel associated with a corresponding spatial parameter.

The network devices 800 and 900 of the embodiments of the present disclosure may realize corresponding functions of the network device in the above method embodiments. Processes, functions, implementations and beneficial effects corresponding to each module (submodule, unit, component, or the like) of the network devices 800 and 900 may be referred to the corresponding description in the above method embodiments, which will not be repeated here. It should be noted that the functions described with respect to each module (submodule, unit, component, or the like) in the network devices 800 and 900 of the embodiments of the present disclosure may be implemented by different modules (submodules, units, components, or the like), or may be implemented by the same module (submodule, unit, component, or the like).

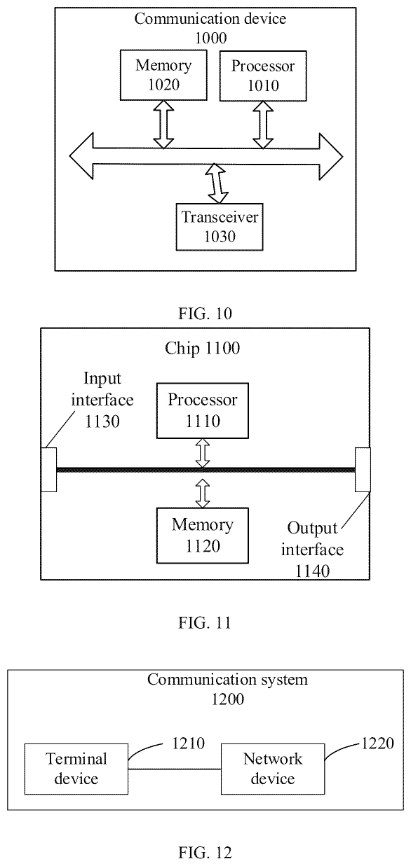

FIG. 10 is a schematic structural diagram of a communication device 1000 according to the embodiments of the present disclosure. The communication device 1000 includes a processor 1010, and processor 1010 may invoke and execute a computer program from a memory to cause the communication device 1000 to implement the methods in the embodiments of the present disclosure.

In a possible implementation, the communication device 1000 may also include a memory 1020. Here, the processor 1010 may invoke and execute a computer program from the memory 1020 to cause the communication device 1000 to implement the methods in the embodiments of the present disclosure.

The memory 1020 may be a separate device independent from the processor 1010 or may also be integrated into the processor 1010.

In a possible implementation, the communication device 1000 may also include a transceiver 1030, and the processor 1010 may control the transceiver 1030 to communicate with other devices, and exemplarily, to transmit information or data to other devices, or receive information or data transmitted by the other devices.

The transceiver 1030 may include a transmitter and a receiver. The transceiver 1030 may further include an antenna. A quantity of the antenna may be one or more.

In a possible implementation, the communication device 1000 may be the network device of the embodiments of the present disclosure, and the communication device 1000 may implement the corresponding processes implemented by the network device in various methods of the embodiments of the present disclosure, which will not be repeated here for the sake of brevity.

In a possible implementation, the communication device 1000 may be the terminal device of the embodiments of the present disclosure, and the communication device 1000 may implement the corresponding processes implemented by the terminal device in various methods of the embodiments of the present disclosure, which will not be repeated here for the sake of brevity.

FIG. 11 is a schematic block diagram of a chip 1100 according to an embodiment of the present disclosure. The chip 1100 includes a processor 1110, and the processor 1110 may invoke and execute a computer program from a memory to implement the methods in the embodiments of the present disclosure.

In a possible implementation, chip 1100 may also include memory 1120. The processor 1110 may invoke and execute a computer program from a memory 1120 to implement the methods performed by the terminal device or the network device in the embodiments of the present disclosure.

The memory 1120 may be a separate device independent from the processor 1110, or may also be integrated into the processor 1110.

In a possible implementation, the chip 1100 may further include an input interface 1130. Here, the processor 1110 may control the input interface 1130 to communicate with other devices or chips, and exemplarily, to obtain information or data transmitted by other devices or chips.

In a possible implementation, the chip 1100 may further include an output interface 1140. Here, the processor 1110 may control the output interface 1140 to communicate with other devices or chips, and exemplarily, to output information or data to other devices or chips.

In a possible implementation, the chip may be applied to the network device in the embodiments of the present disclosure, and the chip may implement the corresponding processes implemented by the network device in the various methods of the embodiments of the present disclosure, which will not be repeated here for the sake of brevity.

In a possible implementation, the chip may be applied to the terminal device in the embodiments of the present disclosure, and the chip may implement the corresponding processes implemented by the terminal device in the various methods of the embodiments of the present disclosure, which will not be repeated here for the sake of brevity.

The chips applied to the network device and the terminal device may be the same chip or different chips.

It should be understood that, the chip mentioned in the embodiments of the present disclosure may also be referred to as a system-level chip, a system chip, a chip system or a system-on-chip chip, or the like.

The processor mentioned above may be a general-purpose processor, a digital signal processor (DSPS), a field programmable gate array (FPGA), an application specific integrated circuit (ASIC), or other programmable logic devices, transistor logic devices or discrete hardware components. Here, the general-purpose processor mentioned above may be a microprocessor or may also be any conventional processor, or the like.

The memory mentioned above may be a volatile (transitory) memory or a non-volatile (non-transitory) memory, or may include both the volatile memory and the non-volatile memory. Here, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM) or flash memory. The volatile memory may be a random access memory (RAM).

It should be understood that the above memory is exemplary but not limited illustration. For example, the memory in the embodiments of the present disclosure may also be a static random access memory (static RAM, SRAM), a dynamic random access memory (dynamic RAM, DRAM), a synchronous dynamic random access memory (synchronous DRAM, SDRAM)), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct Rambus random access memory (Direct Rambus RAM, DR RAM), or the like. That is, the memory in the embodiments of the present disclosure is intended to include, but not limited to, these and any other suitable types of memories.

FIG. 12 is a schematic block diagram of a communication system 1200 according to the embodiments of the present disclosure. The communication system 1200 includes a terminal device 1210 and a network device 1220.

The terminal device 1210 is configured to receive indication information, the indication information being used for indicating a combination of a number of transmission layers of at least one uplink channel; and
a network device 1220 is configured to transmit indication information, the indication information being used for indicating a combination of a number of transmission layers of at least one uplink channel.

The terminal device 1210 may be used to implement the corresponding functions implemented by the terminal device in the above methods, and the network device 1220 may be used to implement the corresponding functions implemented by the network device in the above methods, which will not be repeated here for the sake of brevity.

The above embodiments may be implemented in whole or in part by software, hardware, firmware, or any combination thereof. When the above embodiments are implemented by using software, they may be implemented in a form of a computer program product in whole or in part. The computer program product includes one or more computer instructions. When computer program instructions are loaded and executed on a computer, processes or functions according to the embodiments of the present disclosure are generated in whole or in part. The computer may be a general-purpose computer, a dedicated computer, a computer network, or any other programmable apparatus. The computer instructions may be stored in a computer-readable storage medium or transmitted from one computer-readable storage medium to another computer-readable storage medium, for example, the computer instructions may be transmitted from a website site, computer, server, or data center to another website site, computer, server, or data center via wired (such as coaxial cable, fiber optic, digital subscriber line (DSL)) or wireless (such as infrared, radio, microwave) means. The computer-readable storage medium may be any available medium that can be accessed by the computer, or a data storage device, such as including a server or a data center that integrates one or more available mediums. The available medium may be a magnetic medium (e.g., a floppy disk, a hard disk or a magnetic tape), an optical medium (e.g., a digital video disk (DVD)), a semiconductor medium (e.g., a solid state disk (SSD)), or the like.

It should be understood that, in the various embodiments of the present disclosure, a size of serial numbers of the above processes does not imply an order of execution, and the execution order of the respective processes should be determined by their function and internal logic, but should not constitute any limitation on the implementation processes of the embodiments of the present disclosure.

Those skilled in the art may clearly understand that, for the convenience and brevity of the description, the specific working processes of the systems, apparatus and units described above may refer to the corresponding processes in the above method embodiments, which will not be repeated here.

The foregoing descriptions are merely specific implementations of the present disclosure, but the protection scope of the present disclosure is not limited thereto. Any skilled person in the art could readily conceive of changes or replacements within the technical scope of the present disclosure, which shall be all included in the protection scope of the present disclosure. Therefore, the protection scope of the present disclosure shall be subject to the protection scope of claims.

What is claimed is:

1. An indication method, comprising:
receiving, by a terminal device, indication information, the indication information being used for indicating a combination of a number of transmission layers of at least one uplink channel.

2. The method according to claim 1, wherein
each uplink channel is associated with a spatial parameter, and the spatial parameter comprises at least one of: transmission configuration indicator (TCI) state information, capability set information, antenna panel information, transmission reception point (TRP) information, control resource set (CORESET) information, reference signal set information, a sounding reference signal (SRS) resource set, reference signal information, or beam information.

3. The method according to claim 1, wherein
the indication information comprises first information, and the first information is used for indicating the combination of the number of transmission layers of the at least one uplink channel; and
the indication information further comprises second information, and the second information is used for indicating an association relationship between the combination of the number of transmission layers of the at least one uplink channel and a spatial parameter.

4. The method according to claim 3, wherein, in a case where a quantity of a number of transmission layers comprised in the combination of the number of transmission layers of the at least one uplink channel is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter; or
in a case where a quantity of a number of transmission layers comprised in the combination of the number of transmission layers of the at least one uplink channel is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

5. The method according to claim 3, wherein
the indication information further comprises a first SRS resource indicator and/or a second SRS resource indicator; wherein
the first SRS resource indicator is used for indicating one or more SRS resources in a first SRS resource set; and
the second SRS resource indicator is used for indicating one or more SRS resources in a second SRS resource set.

6. The method according to claim 5, wherein the second information is further used for indicating an association relationship of the combination of the number of transmission layers of the at least one uplink channel with the first SRS resource indicator and/or the second SRS resource indicator.

7. The method according to claim 6, wherein, in a case where a quantity of a number of transmission layers comprised in the combination of the number of transmission layers of the at least one uplink channel is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator; or
in a case where a quantity of a number of transmission layers comprised in the combination of the number of transmission layers of the at least one uplink channel is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

8. The method according to claim 3, wherein
the indication information further comprises first precoding information and/or second precoding information; and
the second information is further used for indicating an association relationship of the combination of the number of transmission layers of the at least one uplink channel with the first precoding information and/or the second precoding information.

9. The method according to claim 8, wherein, in a case where a quantity of a number of transmission layers comprised in the combination of the number of transmission layers of the at least one uplink channel is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information; or
in a case where a quantity of a number of transmission layers comprised in the combination of the number of transmission layers of the at least one uplink channel is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

10. The method according to claim 1, further comprising:
transmitting, by the terminal device, the at least one uplink channel according to the indication information;
wherein transmitting, by the terminal device, the at least one uplink channel according to the indication information comprises:
determining, by the terminal device according to the indication information, at least one of:
the number of transmission layers of the at least one uplink channel;
a spatial parameter associated with a number of transmission layers of each uplink channel;
an SRS resource indicator associated with a number of transmission layers of each uplink channel; or
precoding information associated with a number of transmission layers of each uplink channel; and
transmitting, by the terminal device, an uplink channel according to determined content.

11. An indication method, comprising:
transmitting, by a network device, indication information, the indication information being used for indicating a combination of a number of transmission layers of at least one uplink channel.

12. The method according to claim 11, wherein
each uplink channel is associated with a spatial parameter, and the spatial parameter comprises at least one of: transmission configuration indicator (TCI) state information, capability set information, antenna panel information, transmission reception point (TRP) information, control resource set (CORESET) information, reference signal set information, a sounding reference signal (SRS) resource set, reference signal information, or beam information.

13. The method according to claim 11, wherein
the indication information comprises first information, and the first information is used for indicating the combination of the number of transmission layers of the at least one uplink channel; and
the indication information further comprises second information, and the second information is used for indicating an association relationship between the combination of the number of transmission layers of the at least one uplink channel and a spatial parameter.

14. The method according to claim 13, wherein, in a case where a quantity of a number of transmission layers comprised in the combination of the number of transmission layers of the at least one uplink channel is one:
when a state value of the second information is a first value, it is indicated that a number of transmission layers in the combination of the number of transmission layers of the at least one uplink channel is associated with a first spatial parameter; or
when a state value of the second information is a second value, it is indicated that a number of transmission layers in the combination of the number of transmission layers of the at least one uplink channel is associated with a second spatial parameter; or
in a case where a quantity of a number of transmission layers comprised in the combination of the number of transmission layers of the at least one uplink channel is two:
when a state value of the second information is a third value, it is indicated that a first number of transmission layers in the combination of the number of transmission layers of the at least one uplink channel is associated with a first spatial parameter, and a second number of transmission layers in the combination of the number of transmission layers of the at least one uplink channel is associated with a second spatial parameter; or
when a state value of the second information is a fourth value, it is indicated that a first number of transmission layers in the combination of the number of transmission layers of the at least one uplink channel is associated with a second spatial parameter, and a second number of transmission layers in the combination of the number of transmission layers of the at least one uplink channel is associated with a first spatial parameter.

15. The method according to claim 13, wherein
the indication information further comprises a first SRS resource indicator and/or a second SRS resource indicator; wherein
the first SRS resource indicator is used for indicating one or more SRS resources in a first SRS resource set; and
the second SRS resource indicator is used for indicating one or more SRS resources in a second SRS resource set; and
wherein the second information is further used for indicating an association relationship of the combination of the number of transmission layers of the at least one uplink channel with the first SRS resource indicator and/or the second SRS resource indicator.

16. The method according to claim 15, wherein, in a case where a quantity of a number of transmission layers comprised in the combination of the number of transmission layers of the at least one uplink channel is one:
when a state value of the second information is a fifth value, it is indicated that a number of transmission layers in the combination of the number of transmission layers of the at least one uplink channel is associated with the first SRS resource indicator; or
when a state value of the second information is a sixth value, it is indicated that a number of transmission layers in the combination of the number of transmission layers of the at least one uplink channel is associated with the second SRS resource indicator; or
in a case where a quantity of a number of transmission layers comprised in the combination of the number of transmission layers of the at least one uplink channel is two:
when a state value of the second information is a seventh value, it is indicated that a first number of transmission layers in the combination of the number of transmission layers of the at least one uplink channel is associated with the first SRS resource indicator, and a second number of transmission layers in the combination of the number of transmission layers of the at least one uplink channel is associated with the second SRS resource indicator; or
when a state value of the second information is an eighth value, it is indicated that a first number of transmission layers in the combination of the number of transmission layers of the at least one uplink channel is associated with the second SRS resource indicator, and a second number of transmission layers in the combination of the number of transmission layers of the at least one uplink channel is associated with the first SRS resource indicator.

17. The method according to claim 13, wherein
the indication information further comprises first precoding information and/or second precoding information; and
the second information is further used for indicating an association relationship of the combination of the number of transmission layers of the at least one uplink channel with the first precoding information and/or the second precoding information.

18. The method according to claim 17, wherein, in a case where a quantity of a number of transmission layers comprised in the combination of the number of transmission layers of the at least one uplink channel is one:
when a state value of the second information is a ninth value, it is indicated that a number of transmission layers in the combination of the number of transmission layers of the at least one uplink channel is associated with the first precoding information; or
when a state value of the second information is a tenth value, it is indicated that a number of transmission layers in the combination of the number of transmission layers of the at least one uplink channel is associated with the second precoding information; or
in a case where a quantity of a number of transmission layers comprised in the combination of the number of transmission layers of the at least one uplink channel is two:
when a state value of the second information is an eleventh value, it is indicated that a first number of transmission layers in the combination of the number of transmission layers of the at least one uplink channel is associated with the first precoding information, and a second number of transmission layers in the combination of the number of transmission layers of the at least one uplink channel is associated with the second precoding information; or
when a state value of the second information is a twelfth value, it is indicated that a first number of transmission layers in the combination of the number of transmission layers of the at least one uplink channel is associated with the second precoding information, and a second number of transmission layers in the combination of the number of transmission layers of the at least one uplink channel is associated with the first precoding information.

19. The method according to claim 11, further comprising,
receiving the at least one uplink channel transmitted according to the indication information.

20. A terminal device, comprising: a processor and a memory, wherein the memory is configured to store a computer program, and the processer is configured to invoke and execute the computer program stored in the memory, to cause the terminal device to perform:
receiving indication information, the indication information being used for indicating a combination of a number of transmission layers of at least one uplink channel.
